(19) United States
(12) Patent Application Publication
(10) Pub. No.: US 2009/0183348 A1
(43) Pub. Date: Jul. 23, 2009

(54) BUCKLE ASSEMBLIES AND ASSOCIATED CONNECTORS FOR USE WITH CHILD SEATS AND OTHER RESTRAINT SYSTEMS

(75) Inventors: Michael J. Walton, Phoenix, AZ (US); Xinhua Huang, Nanxi/Sichuan (CN); Wenyu Jin, Kunshan/Jiangsu (CN); Yuhong Liu, Suzhou/Jiangsu (CN)

Correspondence Address: PERKINS COIE LLP;PATENT-SEA, P.O. BOX 1247, SEATTLE, WA, 98111-1247, US

(73) Assignee: AmSafe Commercial Products, Inc., Elkhart, IN (US)

(21) Appl. No.: 12/357,356

(22) Filed: Jan. 21, 2009

Related U.S. Application Data
(60) Provisional application No. 61/011,833, filed on Jan. 22, 2008.

(51) Int. Cl. B60R 22/18; B60R 22/10; B60R 22/00

(52) U.S. Cl. 24/633; 297/468; 280/801.1

(57) ABSTRACT

Buckle assemblies and associated connectors for use with child seats and other personal restraint systems are disclosed herein. A restraint system configured in accordance with one embodiment of the invention includes shoulder/lap webs which are slideably received in corresponding web connectors. Each of the web connectors includes a tongue portion that is configured to releasably interlock with the other tongue portion before the interlocking tongue portions are simultaneously inserted into the buckle assembly as a unit. The buckle assembly is configured to receive and engage the interlocking tongue portions only when the tongue portions have been properly mated together prior to insertion into the buckle assembly.

### CROSS-REFERENCE TO RELATED APPLICATION(S) INCORPORATED BY REFERENCE

The present application claims the benefit of and priority to U.S. Provisional Patent Application No. 61/011,833, filed Jan. 22, 2008 and incorporated herein in its entirety by reference.

### TECHNICAL FIELD

The following disclosure relates generally to personal restraint systems for use in vehicles and, more particularly, to buckle assemblies and associated connectors for use with child seats and other restraint systems.

### BACKGROUND

There are many types of personal restraint systems for use in automobiles and other vehicles. Such systems include, for example, seat belts for use by adults and children of sufficient size, and child seats with associated restraints for use by toddlers and small children.

Regulations for child restraint systems often differ between countries and regions. In Europe, for example, requirements for child restraint systems are typically set forth in United Nations ECE Regulation No. 44 (Uniform Provisions Concerning the Approval of Restraining Devices for Child Occupants of Power-Driven Vehicles). As set forth in Section 7.2.1.1 of Regulation No. 44, “. . . the buckle shall be so designed as to preclude any possibility of incorrect manipulation. This means, inter alia, that it must not be possible for the buckle to be left in a partially closed position; it must not be possible to exchange the buckle parts inadvertently when the buckle is being locked; the buckle must only lock when all parts are engaged.” Additionally, Section 7.2.1.4 of Regulation No. 44 states that “it shall be possible to release the child from the restraint by a single operation on a single buckle.”

Accordingly, it would be advantageous to provide child restraint systems having buckles and related components that address, among other things, the requirements set forth in United Nations ECE Regulation No. 44.

### BRIEF DESCRIPTION OF THE DRAWINGS

FIG. 1 is an isometric view of a child secured in a seat with a restraint system having a buckle assembly configured in accordance with an embodiment of the disclosure.

FIGS. 2A-2C are a series of isometric views illustrating various operational aspects of the buckle assembly and web connectors shown in FIG. 1.

FIG. 3 is an exploded isometric view of the buckle assembly of FIGS. 1-2C.

FIGS. 4A-4C are a series of isometric views illustrating a latch sub-assembly configured in accordance with an embodiment of the disclosure.

FIGS. 5A-5C are a series of isometric views illustrating a tongue ejector sub-assembly configured in accordance with an embodiment of the disclosure.

FIGS. 6A-6D are a series of isometric views illustrating various stages in the assembly of the buckle assembly of FIGS. 1-3.

FIGS. 7A-7E are a series of isometric views of the buckle assembly of FIGS. 1-3 with one or more parts omitted to illustrate operation of the latching mechanism in accordance with an embodiment of the disclosure.

FIGS. 8A and 8B are isometric views illustrating operation of a buckle assembly configured in accordance with another embodiment of the disclosure.

FIG. 9 is an exploded isometric view of the buckle assembly of FIGS. 8A and 8B.

FIGS. 10 is an isometric view of a latch sub-assembly configured in accordance with another embodiment of the disclosure.

FIGS. 11A and 11B are isometric views of a connector tongue ejector sub-assembly configured in accordance with another embodiment of the disclosure.

FIGS. 12A-12C are a series of isometric views illustrating various stages in the assembly of the buckle assembly of FIGS. 8A-9.

FIGS. 13A and 13B are isometric views of the buckle assembly of FIGS. 8A-9 with one or more parts omitted to illustrate operation of the latching mechanism in accordance with another embodiment of the disclosure.

FIGS. 14A and 14C are top views of the buckle assembly of FIGS. 8A-9, and FIGS. 14B and 14D are corresponding cross-sectional views taken substantially along line 14B-14B in FIG. 14A, and along line 14D-14D in FIG. 14C, respectively.

### DETAILED DESCRIPTION

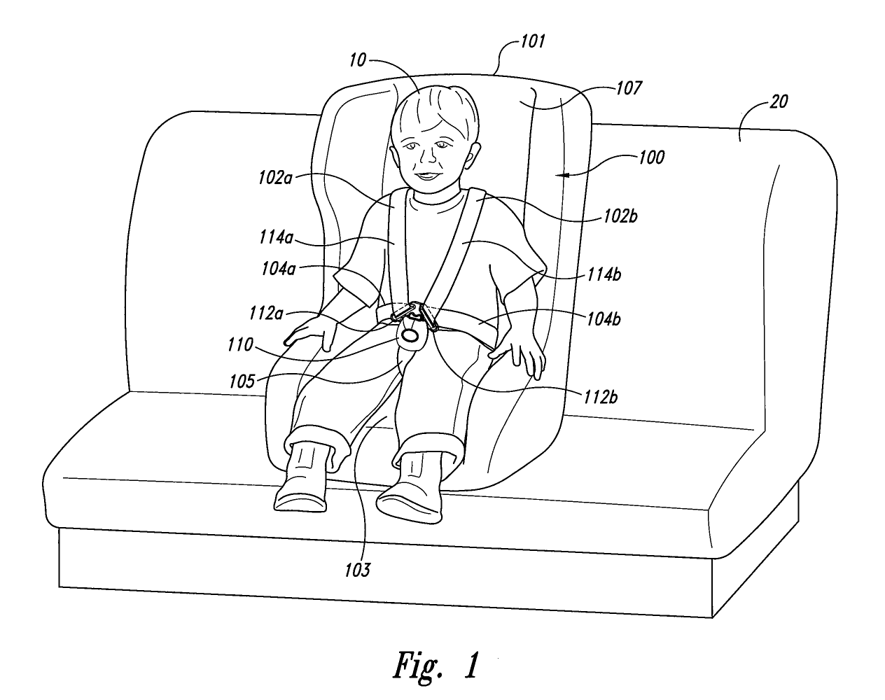

The following disclosure describes buckle assemblies and associated web connectors for use with child seats and other personal restraint systems in vehicles. As described in greater detail below, a personal restraint system configured in accordance with one aspect of the disclosure can include two web connectors with interlocking tongue portions which are concurrently engaged with a corresponding buckle assembly. Certain details are set forth in the following description and in FIGS. 1-14D to provide a thorough understanding of various embodiments of the invention. However, other details describing well-known structures and systems often associated with buckle assemblies, web connectors, and/or other aspects of personal restraint systems are not set forth below to avoid unnecessarily obscuring the description of various embodiments of the invention.

Many of the details, dimensions, angles and other features shown in the Figures are merely illustrative of particular embodiments of the invention. Accordingly, other embodiments can have other details, dimension, angles and features without departing from the spirit or scope of the present disclosure. In addition, those of ordinary skill in the art will appreciate that further embodiments of the invention can be practiced without several of the details described below. In the Figures, identical reference numbers identify identical or at least generally similar elements. To facilitate the discussion of any particular element, the most significant digit or digits of any reference number refers to the Figure in which that element is first introduced. For example, element 110 is first introduced and discussed with reference to FIG. 1.

FIG. 1 is an isometric view illustrating a restraint system 100 having a buckle assembly 110 configured in accordance with an embodiment of the disclosure. In the illustrated embodiment, the restraint system 100 holds a vehicle occupant (e.g., a child 10) in a child seat 101. The child seat 101 includes a base portion 103 and a back portion 107. The child seat 101 can be secured to a vehicle seat 20 using various systems known in the art. Such systems can include, for example, belts or webs (not shown) having proximal ends attached to the child seat 101 and distal ends attached to anchors (also not shown) in the bight of the vehicle seat 20 with suitable couplings. In other embodiments, the child seat 101 can be secured to the vehicle seat 20, and/or other vehicle structures, using other suitable methods known in the art. Moreover, in further embodiments the child seat 101 or variations thereof can be reversed so that the child seat 101 is facing rearward toward the vehicle seat 20. Accordingly, as the foregoing illustrates, embodiments of the present disclosure and applications of the buckle assemblies and web connectors disclosed herein are not limited to the particular child seat configuration illustrated in FIG. 1.

In the illustrated embodiment, the restraint system 100 includes a first shoulder web 102a and a second shoulder web 102b extending from the back portion 107 of the child seat 101. The shoulder webs 102 can include various types of woven fabric materials and/or other suitable belt or strap materials known in the art that provide sufficient strength, flexibility, durability and/or other characteristics. In this embodiment, each of the shoulder webs 102 slidably passes through an aperture in a corresponding web connector 112 (identified individually as a first web connector 112a and a second web connector 112b). Passing the shoulder webs 102 through the web connectors 112 divides each of the shoulder webs 102 into a corresponding shoulder web portion 114 (identified individually as a first shoulder web portion 114a and a second shoulder web portion 114b), and a corresponding lap web portion 104 (identified individually as a first lap web portion 104a and a second lap web portion 104b). The lap web portions 104 extend away from each other toward opposite sides of the bight region of the child seat 101 between the back portion 107 and the seat portion 103. The end portions of the shoulder webs 102 can be secured or otherwise affixed to the child seat 101 and/or other adjacent structures using various methods known in the art.

As described in greater detail below, the web connectors 112 can be releasably coupled to the buckle assembly 110. The buckle assembly 110 is attached to a distal end of a crotch web 105 that extends from the base portion 103 of the child seat 101. The proximal end of the crotch web 105 can be secured to the child seat 101 and/or other adjacent structures using various methods known in the art.

Although FIG. 1 illustrates one possible use of the buckle assembly 110 (e.g., use with a “five point” harness), those of ordinary skill in the art will appreciate that the buckle assembly 110 and the other components of the restraint system 100 can be used in a number of other restraint system applications without departing from the spirit or scope of the present disclosure.

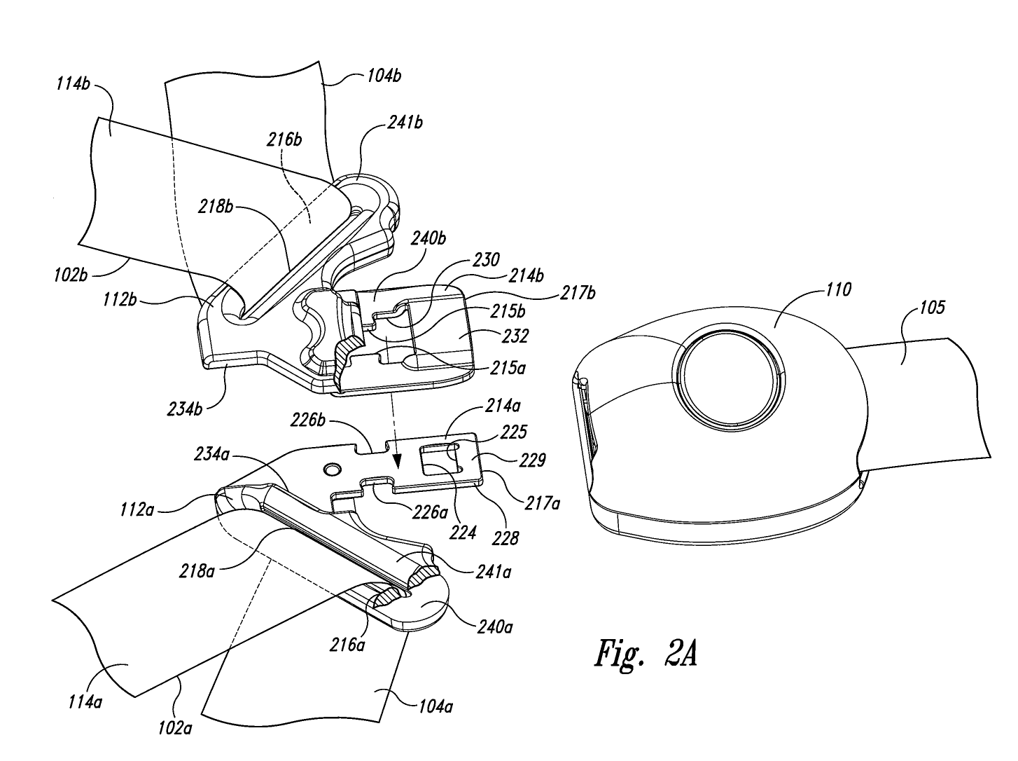

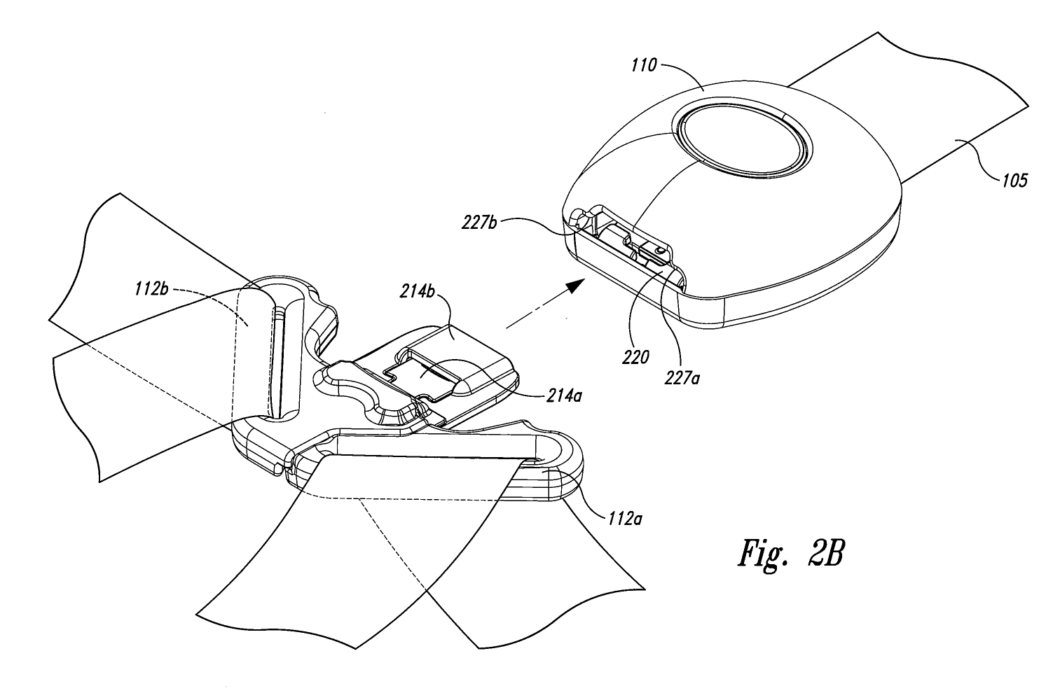

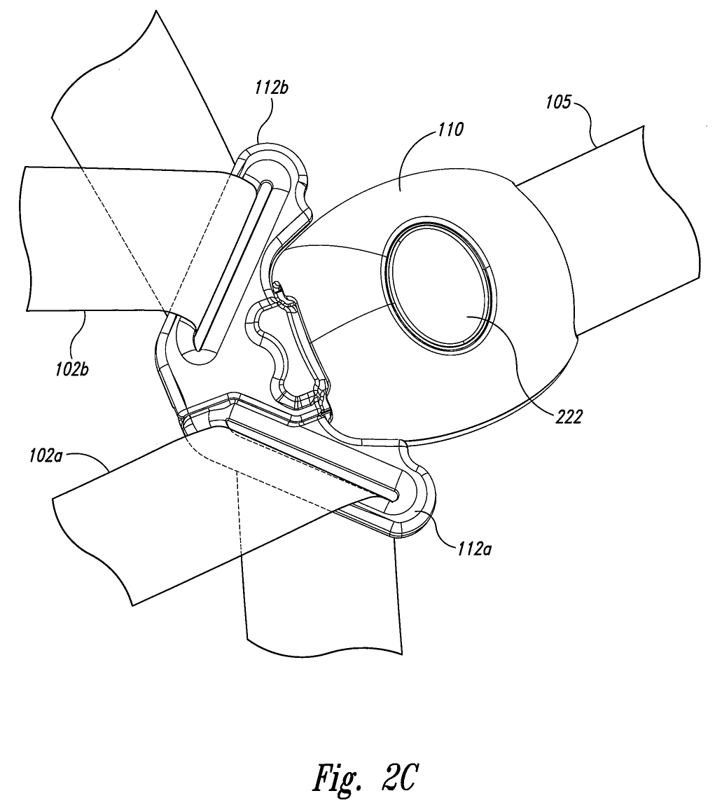

FIGS. 2A-2C are a series of isometric views illustrating various stages in a method of releasably coupling the web connectors 112 to the buckle assembly 110 in accordance with an embodiment of the disclosure. Referring first to FIG. 2A, each of the web connectors 112 includes a connector body 240 (identified individually as a first connector body 240a and a second connector body 240b). Each of the connector bodies 240 includes a tongue portion 214 (identified individually as a first tongue portion 214a and a second tongue portion 214b) and a web receiving portion 216 (identified individually as a first web receiving portion 216a and a second web receiving portion 216b). Each of the tongue portions 214 includes a corresponding distal edge 217 (identified individually as a first distal edge 217a and a second distal edge 217b). Each of the web receiving portions 216 includes a corresponding web aperture 218 (identified individually as a first web aperture 218a and a second web aperture 218b) that slideably receives one of the corresponding shoulder webs 102. In the illustrated embodiment, the web connector bodies 240 can be formed from suitable metallic materials, such as plate steel that is stamped or otherwise formed using suitable methods known in the art.

Each of the web connectors 112 can further include a cover 241 (identified individually as a first cover 241a and a second cover 241b) that fits over the respective web receiving portion 216 of the corresponding connector body 240 to facilitate grasping and manipulation of the web connectors 112 by the user. The covers 241 can have complimentary inner edge profiles 234 that fit together when the connectors 112 are properly mated as shown in FIG. 2B. The covers 241 can be formed from textured plastic and/or other suitable materials known in the art that are bonded, press fit, and/or otherwise attached to the connector bodies 240.

In one aspect of this embodiment, the second tongue portion 214b has one or more inner edges 230 defining an inner shape or profile that is configured to receive and releasably interlock with one or more outer edges 228 of the first tongue portion 214a which define a complementary outer shape or profile. More specifically, in the illustrated embodiment the inner edges 230 of the second tongue portion 214b define a first tab or first projection 215a and a corresponding second projection 215b. Similarly, the outer edges 228 of the first tongue portion 214a define a first cutout or first recess 226a and a corresponding second recess 226b which are shaped and sized to receive the first projection 215a and the second projection 215b, respectively, of the second tongue portion 214b. The matching shapes of the inner edges 230 and the outer edges 228 enable the two tongue portions 214 to be releasably interlocked as shown in FIG. 2B. As those of ordinary skill in the art will appreciate, in other embodiments the edges of the first and second tongue portions 214 can have other interlocking shapes without departing from the present disclosure.

In another aspect of this embodiment, the second tongue portion 214b also includes a raised bridge portion 232 that creates a relief in the second tongue portion 214b that receives a distal end portion 229 of the first tongue portion 214a. As also shown in FIG. 2A, the distal end portion 229 of the first tongue portion 214a includes a locking feature (e.g., a latch pawl aperture 224) having an engagement surface or locking edge 225. In other embodiments, however, the first tongue portion 214a can include other types of locking features, such as a raised portion or step (e.g., a lip) having an abutment surface, a free edge, post, pin, etc.

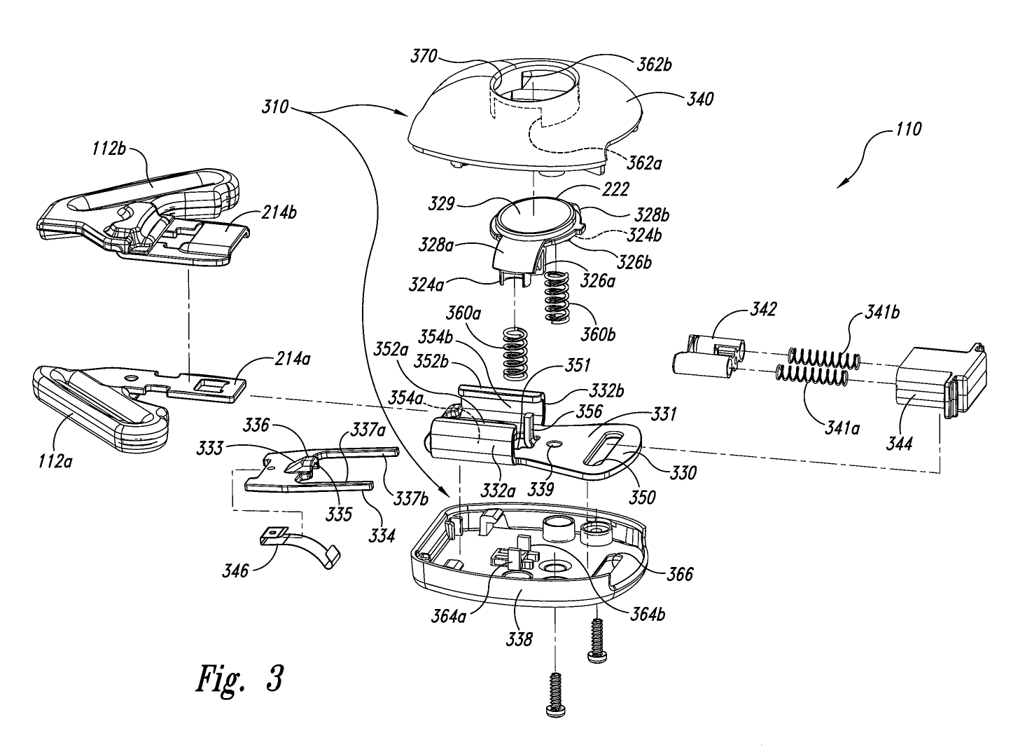

To releasably engage the web connectors 112 with the buckle assembly 110, the first web connector 112a is mated to the second web connector 112b so that the respective tongue portions 214 releasably engage or interlock as shown in FIGS. 2A and 2B. Next, the interlocking tongue portions 214 are inserted through an opening 220 in the buckle assembly 110 as a unit. The tongue portions 214 are pushed into the buckle assembly 110 until they fully engage the buckle assembly 110 as illustrated in FIG. 2C. To release the web connectors 112 from the buckle assembly 110, an operator depresses a release actuator (e.g., a button 222) on the buckle assembly 110. Further details of the web connectors 112 and the buckle assembly 110 are provided below with reference to FIGS. 3-7C.

FIG. 3 is an exploded isometric view illustrating various components and features of the buckle assembly 110 in more detail. In one aspect of this embodiment, the buckle assembly 110 includes a frame 330 positioned in a housing 310. The housing 310 can include a bottom cover 338 and a top cover 340. The top cover 340 can include a button aperture 370 and opposing alignment cutouts 362 (identified individually as a first cutout 362a and a second cutout 362b). The bottom cover 338 can include two frame locating features 364 (identified individually as a first locating feature 364a and a second locating feature 364b) projecting upwardly therefrom, and a first web opening 366 extending therethrough. In one embodiment, the bottom cover 338 and the top cover 340 can be manufactured from plastics (e.g., ejection molded plastics), composites, and/or other suitable non-metallic materials known in the art. In other embodiments, however, the bottom cover 338 and/or the top cover 340 can be formed from suitable metallic materials, such as cast metals.

The frame 330 can include opposing side walls 332 (identified individually as a first side wall 332a and a second side wall 332b) extending upwardly from a base 331. Each of the sidewalls 332 includes a corresponding edge or lip portion 352 (identified individually as a first lip portion 352a and a second lip portion 352b) which extends inwardly so that the respective sidewalls 332 define inner-facing guide channels 354 (identified individually as a first guide channel 354a and a second guide channel 354b). A stop member 356 projects upwardly from the base 331 between an ejector locating aperture 339 and a cover locating aperture 351. The frame 330 further includes an attachment aperture 350 (e.g., a web attachment aperture) positioned toward an end portion of the base 331 for securely attaching the buckle assembly 110 to the crotch web 105 of the restraint system 100 (FIG. 1). In the illustrated embodiment, the frame 330 can be manufactured from a suitable metallic material, such as steel plate that is stamped and formed to shape. In other embodiments, other metals (e.g., other steels, aluminum, etc.) which are stamped, pressed, cast, forged, machined, and/or otherwise formed to shape using suitable methods known in the art can be used. In further embodiments, the frame 330 can be manufactured from composites and/or other nonmetallic materials known in the art having suitable strength, stiffness, and/or other characteristics.

In another aspect of this embodiment, the buckle assembly 110 further includes a latch 334 having a pawl 336 (e.g., a raised pawl) which projects upwardly from a central portion of the latch 334 between opposing side members 337 (identified individually as a first side member 337a and a second side member 337b). The pawl 336 can include an angled ramp portion 333 and an abutment surface 335. In the illustrated embodiment, the side members 337 extend away from the pawl 336 and are parallel, or at least generally parallel to each other with an open space therebetween. The latch 334 can be manufactured from various types of suitable materials known in the art including metallic and nonmetallic materials having suitable strength and stiffness attributes. Such materials can include, for example, suitable steel or aluminum forgings, castings, stampings, etc.

As described in greater detail below, the latch 334 can be operably coupled to a resilient biasing member or spring 346. In the illustrated embodiment, the spring 346 is a curved member formed from spring steel. In other embodiments, however, other types of resilient biasing members (e.g., coil springs, torsion springs, etc.) can be utilized to bias or urge the latch 334 in a desired direction during operation of the buckle assembly 110.

In a further aspect of this embodiment, the release button 222 includes two support arms 328 (identified individually as a first support arm 328a and a second support arm 328b) extending outwardly from opposite sides of a contact surface 329. Each of the support arms 328 can include a corresponding spring holder 324 (identified individually as a first spring holder 324a and a second spring holder 324b). Each of the spring holders 324 retains an end portion of a corresponding coil spring 360 (identified individually as a first coil spring 360a and a second coil spring 360b). The coil springs 360 bias the release button 222 upwardly against the top cover 340 of the housing 310 to accessibly position the contact surface 329 in the button aperture 370. The support arms 328 are slidably engaged with the alignment cutouts 362 in the top cover 340 to maintain proper alignment of the release button 222 during operation. In one embodiment, the release button 222 can be manufactured from plastics (e.g., ejection molded plastics), composites, and/or other suitable non-metallic materials known in the art. In other embodiments, however, the release button 222 can be formed from suitable metallic materials, such as cast metals.

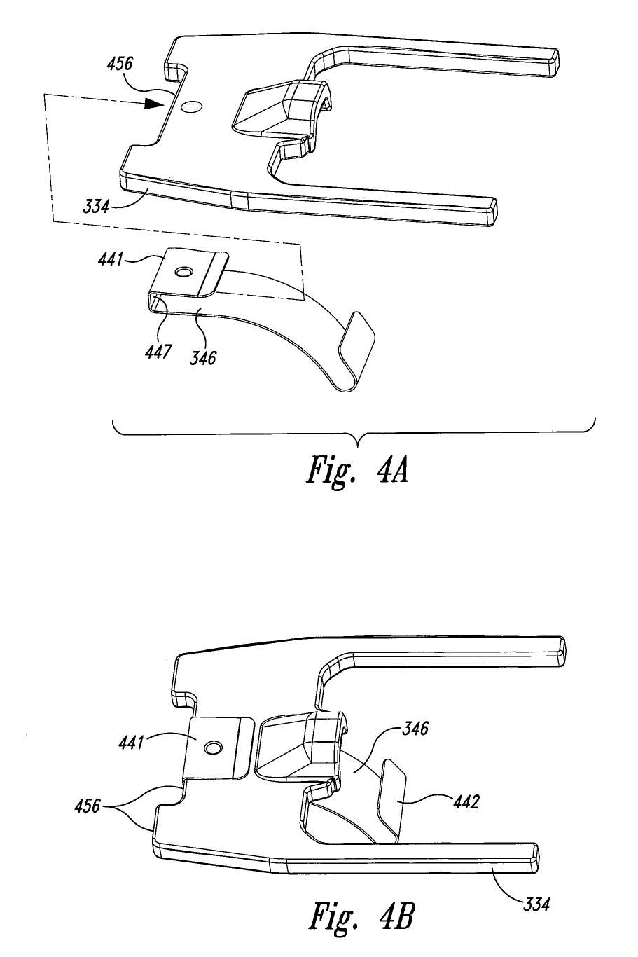

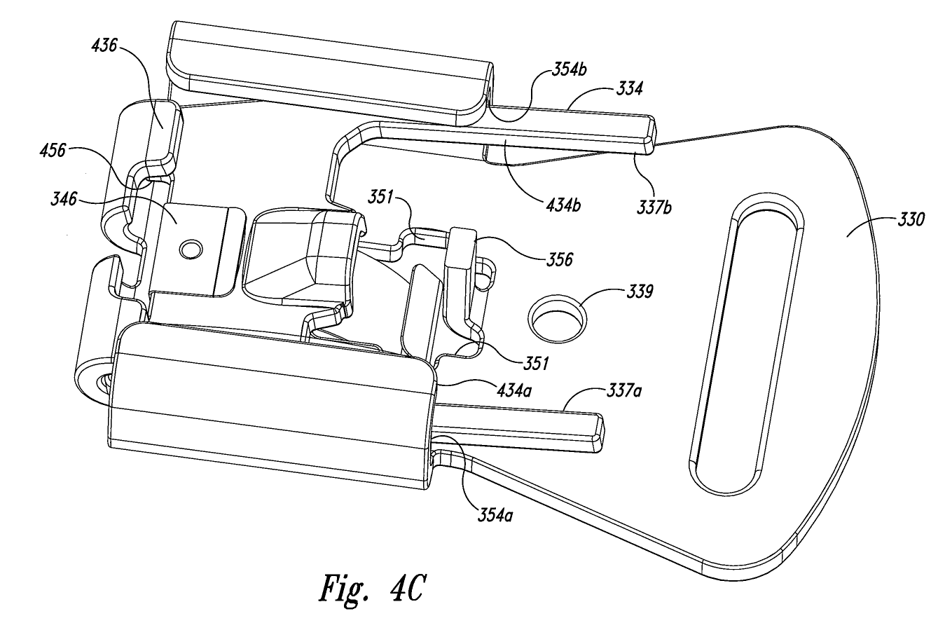

In the illustrated embodiment, the release button 222 can further include two legs 326 (identified individually as a first leg 326a and a second leg 326b) extending downwardly adjacent to the spring holders 324. The distal end portions of the legs 326 are configured to push downwardly against the side members 337 of the latch 334 when the release button 222 is depressed against the coil springs 360. As described in greater detail below, the resulting downward movement of the latch side members 337 causes the latch pawl 336 to disengage from the tongue portions 114 of the connectors 112. When this occurs, an ejector 342 pushes the tongue portions 114 out of the buckle assembly 110 by virtue of a first biasing member or coil spring 341a and a second coil spring 341b which are compressed against an ejector base 344. Further description of the assembly and operation of the various buckle components is provided below with reference to FIGS. 4A-7C.

FIGS. 4A-4C are a series of isometric views illustrating the installation of the latch spring 346 on the latch 334, and subsequent installation of the latch 334 on the frame 330. As shown in FIGS. 4A and 4B, a proximal end portion 441 of the latch spring 346 is formed into a U-shaped pocket 447 that receives a leading edge portion 456 of the latch 334. When the leading edge portion 456 of the latch 334 is inserted into the U-shaped pocket 447, a distal end portion 442 of the latch spring 346 is offset from the latch 334 as shown in FIG. 4B. As shown in FIG. 4C, after the latch spring 346 has been operably coupled to the latch 334, the latch side members 337 can be slid into the corresponding guide channels 354 of the frame 330 until the leading edge portion 456 of the latch 334 is behind a return flange 436. The leading edge portion 456 can then be moved downwardly and under the return flange 436 on the frame 330 to retain the latch 334 in the position shown in FIG. 4C.

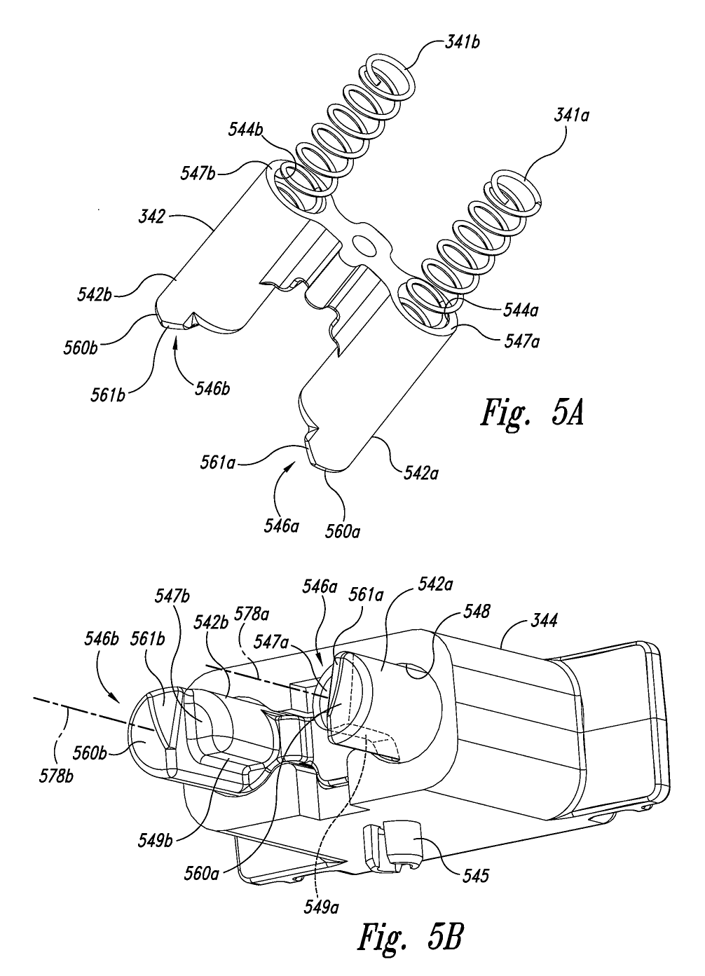

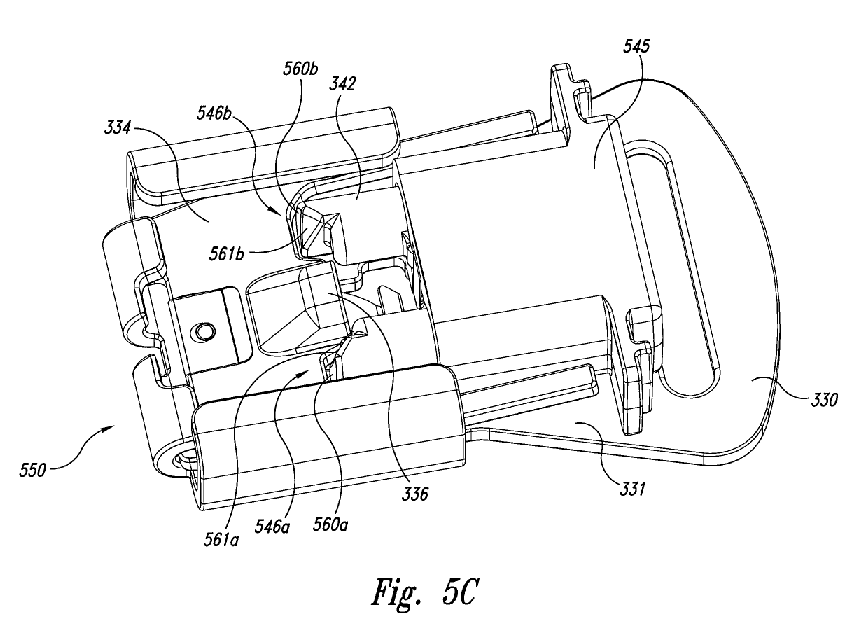

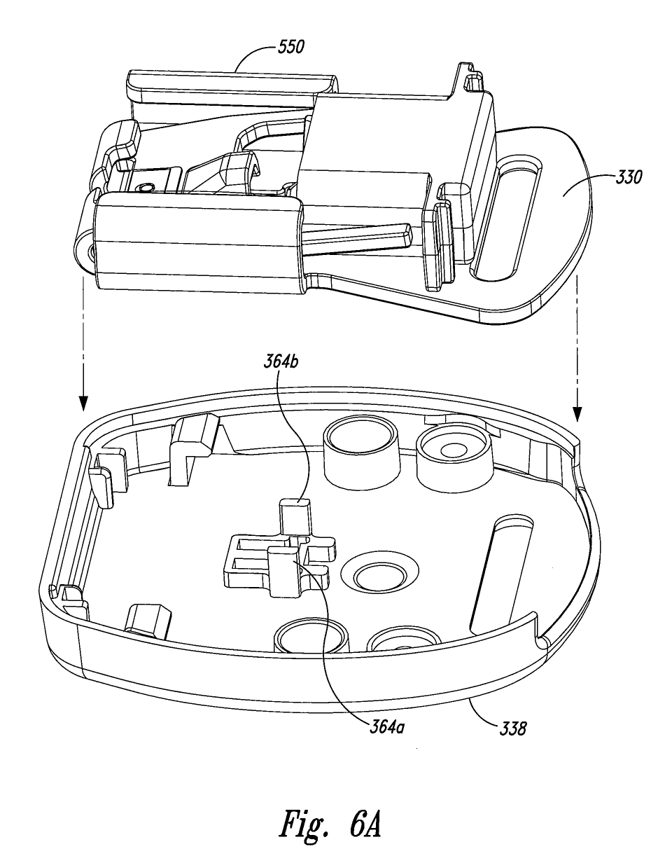

FIGS. 5A-5C are a series of isometric views illustrating the assembly of an ejector subassembly 545, and subsequent installation of the ejector subassembly 545 on the latch frame 330. Referring first to FIG. 5A, the ejector 342 of the illustrated embodiment includes a first leg 542a and a corresponding second leg 542b. In this embodiment, the two legs 542 can be parallel, or at least generally parallel to each other, and can be mirror images of each other. Each of the legs 542 includes a distal end portion 546 (identified individually as a first distal end portion 546a and a second distal end portion 546b), and a corresponding proximal end portion 547 (identified individually as a first proximal end portion 547a and a second proximal end portion 547b). In this embodiment, each of the proximal end portions 547 includes a corresponding spring cavity 544 (identified individually as a first spring cavity 544a and a second spring cavity 544b) that receives a corresponding one of the coil springs 341.

As shown in FIG. 5B, the proximal end of the ejector 342 is slidably inserted into the ejector base 344 through an ejector aperture 548 to compress the coil springs 341 therewithin. As this Figure shows, in the illustrated embodiment each of the distal end portions 546 of the ejector legs 542 includes a tip surface 560, an adjacent chamfered or beveled surface 561, a recessed or offset surface 547, and an undercut region 549. In this embodiment, each of the tip surfaces 560 can be perpendicular to, or at least approximately perpendicular to, a longitudinal axis 578 of the corresponding ejector leg 542. As described in greater detail below, the tip surfaces 560 of the ejector legs 542 are configured to contact at least one of the tongue portions 214 (e.g., the second tongue portion 214b) of the web connectors 112 and be pushed back into the ejector base 344 against the springs 341 when the interlocking tongue portions 214 are properly inserted into the buckle assembly 110 (FIGS. 2A-3). Moreover, the offset surfaces 547 and the undercut regions 549 of the ejector legs 542 are configured to provide clearance and facilitate movement of the ejector 342 relative to the latch pawl 336 and the frame locating features 364 (FIG. 3), respectively, when the ejector legs 542 move outwardly from the ejector base 344 during operation of the ejector 342.

In another aspect of this embodiment, each of the beveled surfaces 561 can be positioned at an angle relative to the corresponding tip surface 560. For example, each of the beveled surfaces 561 can be positioned at an included angle of from about 115 degrees to about 165 degrees relative to the corresponding tip surface 560. In another embodiment, each of the beveled surfaces 561 can be positioned at an included angle of from about 125 degrees to about 145 degrees, or about 135 degrees relative to the corresponding tip surface 560. As shown in FIG. 5B, each of the beveled surfaces 561 of the illustrated embodiment can also be canted back so that it faces slightly upward relative to a plane passing through the longitudinal axes 578 of both ejector legs 542. For example, in one embodiment each of the beveled surfaces 561 can be positioned at an included angle of from about 80 degrees to about 40 degrees relative to such a plane. In another embodiment, each of the beveled surfaces 561 can be positioned at an included angle of from about 75 degrees to about 50 degrees, or about 65 degrees relative to the plane passing through the longitudinal axes 578 of the ejector legs 542.

In the illustrated embodiment, the beveled surfaces 561 and/or the tip surfaces 560 can be planar, or at least generally planar. In other embodiments, however, the beveled surfaces 561 and/or the tip surfaces 560 can be curved, or slightly curved. For example, in one embodiment the beveled surfaces 561 and/or the tip surfaces 560 can be slightly spherically or cylindrically concave. In another embodiment, the beveled surfaces 561 and/or the tip surfaces 560 can be slightly spherically or cylindrically convex. In yet other embodiments, it is contemplated that the beveled surfaces 561 and/or the tip surfaces 560 can have other shapes consistent with the present disclosure.

As described in greater detail below, the beveled surfaces 561 on the distal end portions 546 of the ejector legs 542 are configured to prevent the first tongue portion 214a from inadvertently engaging the latch pawl 336 when the first tongue portion 214a is inserted into the latch assembly 110 in the absence of the second tongue portion 214b. In other embodiments, however, the distal end portions 546 of the ejector legs 542 can have configurations that differ from those described above without departing from the present disclosure. In the illustrated embodiment, the ejector 342 and/or the ejector base 344 can be made from a suitable plastic material, such as injection molded plastic. In other embodiments, however, one or both of these components can be made from other suitable materials, such as cast metal, etc.

Moving next to FIG. 5C, the ejector subassembly 545 is installed on the frame 330 between the leg members 337 of the latch. As shown in FIG. 5B, the ejector base 344 includes an alignment feature 545 (e.g., a post or other projection) that extends downwardly from the ejector base 344. The alignment feature 545 is received in the ejector locating aperture 339 in the frame base 331 to correctly position the ejector subassembly 545 as shown in FIG. 5C. When the ejector subassembly 545 is in this position, the distal end portions 546 of the ejector legs 342 are positioned on opposite sides of the latch pawl 336. For ease of reference, the subassembly illustrated in FIG. 5C is referred to herein as a latch subassembly 550.

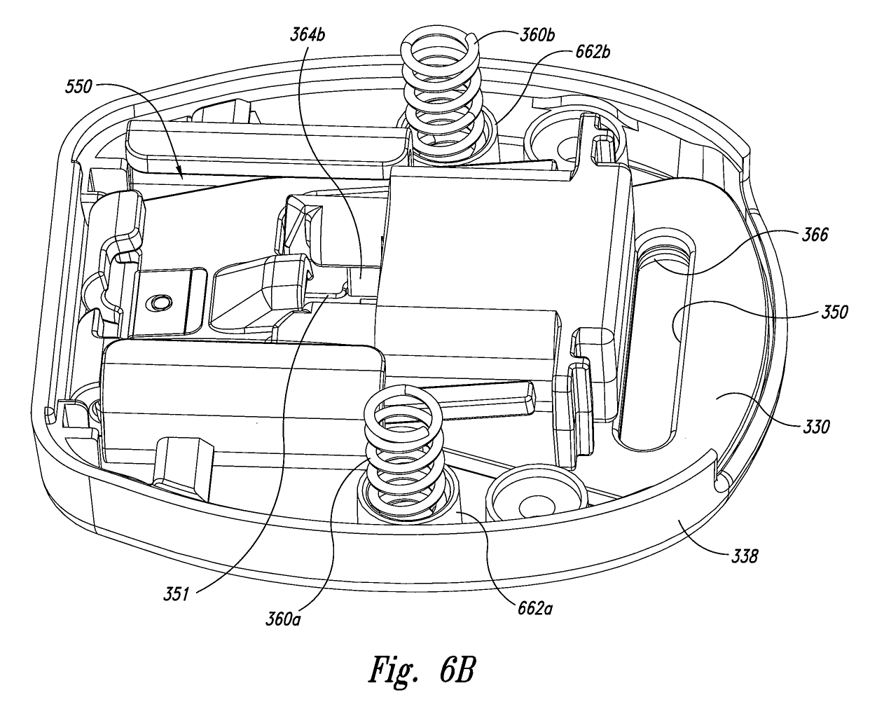

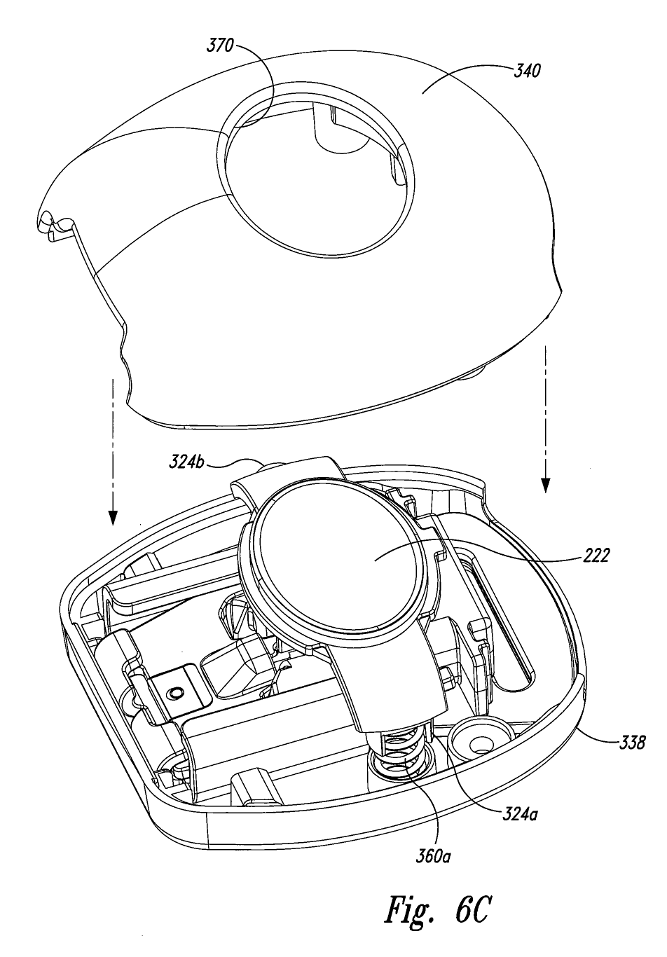

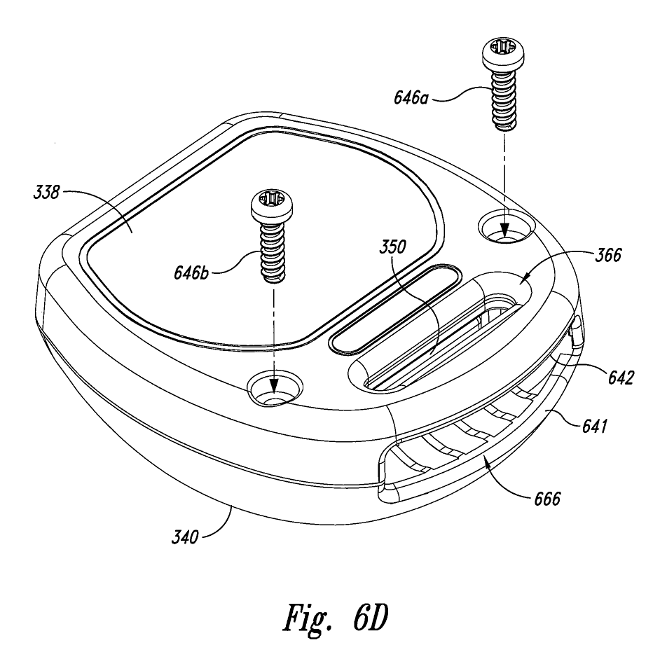

FIGS. 6A-6D are a series of isometric views illustrating various steps in the final assembly of the buckle assembly 110 described above with reference to FIGS. 2A-5C. Referring to FIGS. 3, 6A and 6B together, the latch subassembly 550 is positioned in the bottom cover 338 of the buckle housing 310 so that the frame locating features 364 extend upwardly through the cover locating aperture 351. In this position, the first web opening 366 in the bottom cover 338 is aligned with the attachment aperture 350 in the frame 330. The first coil spring 360a and the second coil spring 360b are positioned in corresponding spring sockets 662 (identified individually as a first spring socket 662a and a second spring socket 662b) in the bottom cover 338 on either side of the latch subassembly 550. The release button 222 is then positioned over the latch subassembly 550 so that the coil springs 360 extend upwardly into the corresponding spring holders 324, as shown in FIG. 6C.

Next, the top cover 340 is mated to the bottom cover 338 so that the release button 222 is accessible via the button aperture 370. As shown in FIG. 6D, the top cover 340 can then be secured to the bottom cover 338 by a plurality fasteners, such as screws (identified individually as a first fastener 646a and a second fastener 646b), and/or other suitable threaded or non-threaded fasteners, snap-together features, adhesives, and/or other suitable methods known in the art. The top cover 340 includes a first cutout 641 and the bottom cover 338 includes an adjacent second cutout 642 that together form a second web opening 666 when assembled as shown in FIG. 6D. The second web opening 666 together with the first web opening 366 permit an attachment member, such as a web (e.g., the crotch web 105 of FIGS. 1-2C) to be looped through the attachment aperture 350 in the frame 330 for securing the buckle assembly 110 to a child seat or other structure.

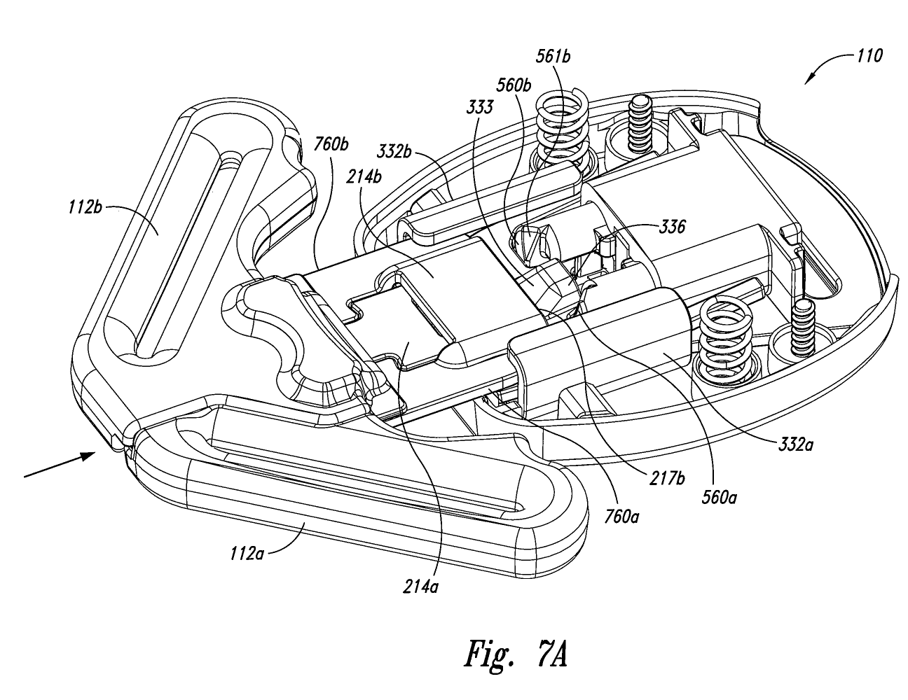

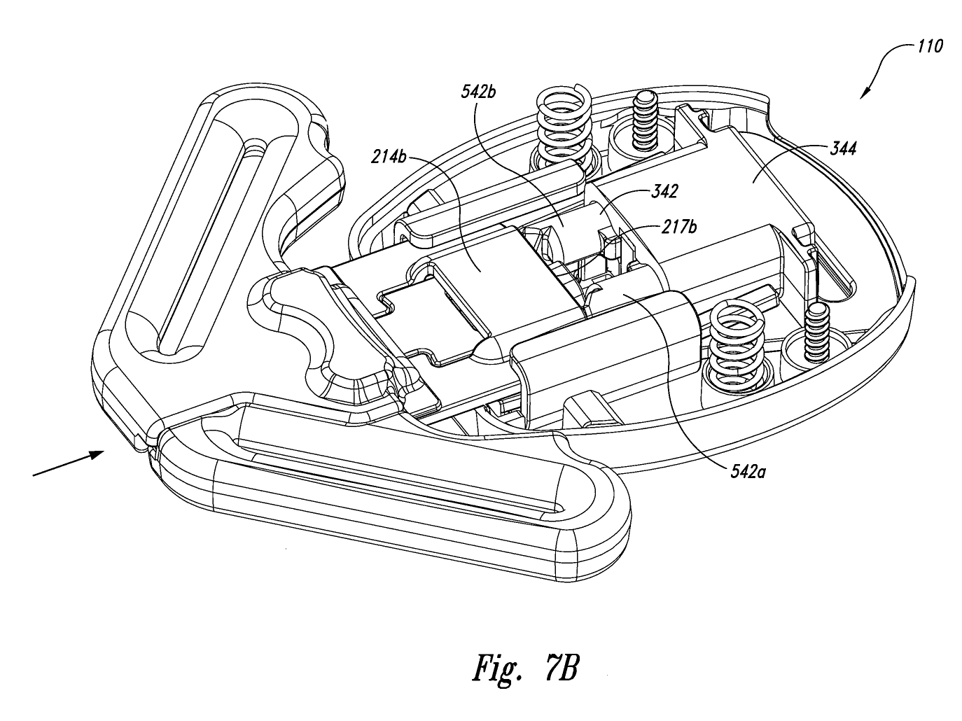

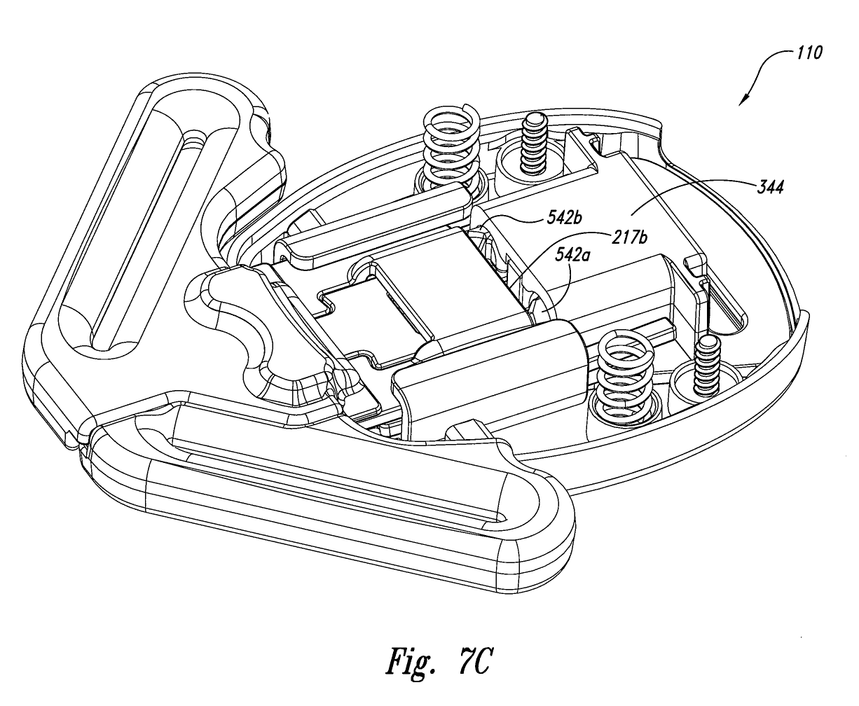

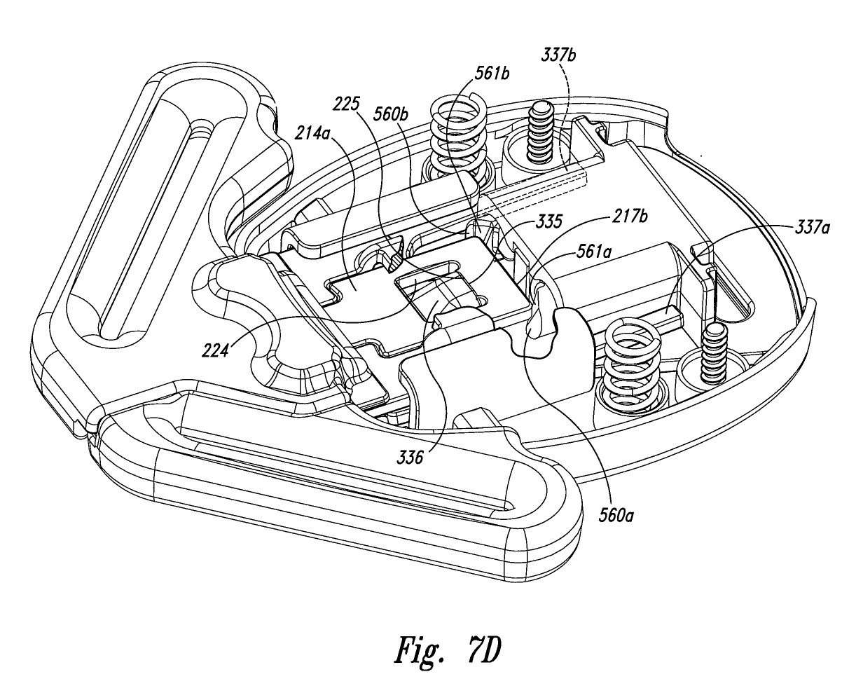

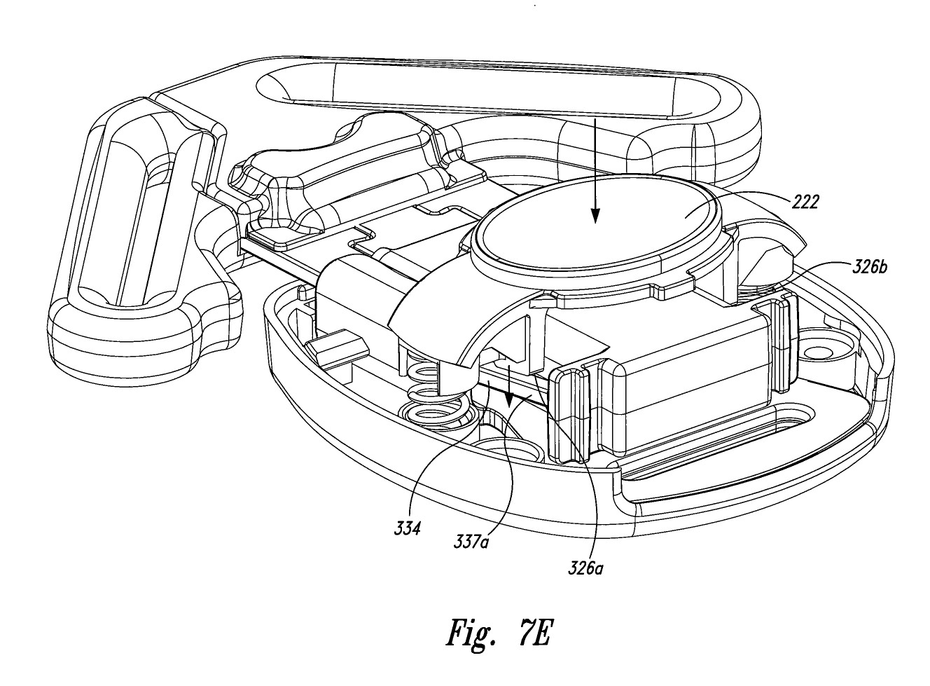

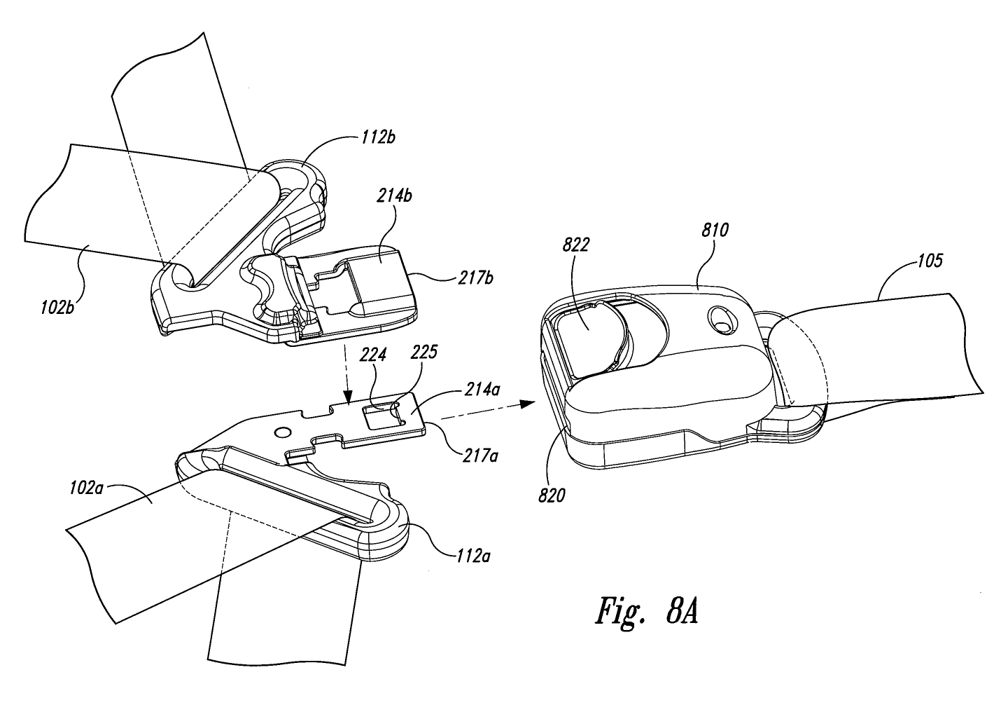

FIGS. 7A-7E are a series of partially assembled isometric views illustrating operation of the buckle assembly 110 in accordance with an embodiment of the disclosure. In FIGS. 7A-7C, the release button 222 and the upper cover 340 of the housing 310 have been omitted for clarity. Referring first to FIG. 7A, a user (not shown) correctly mates the first connector 112a to the second connector 112b as shown in FIGS. 2A and 2B, and then inserts the interlocking tongue portions 214 into the buckle assembly 110 through the opening 220. When the tongue portions 214 are properly inserted into the buckle assembly 110, outer edges 760 (identified individually as a first outer edge 760a and a second outer edge 760b) of the second tongue portion 214b are slideably received in the guide channels 354 (FIG. 3) defined by the frame side walls 332. In the position shown in FIG. 7A, the first distal edge 217a (FIG. 2A) of the first tongue portion 214a has just contacted the angled ramp portion 333 of the latch pawl 336, and has begun to move the latch pawl 336 downwardly against the biasing force of the latch spring 346 (FIGS. 3-4C).

Referring next to FIG. 7B, as the user continues pushing the interlocking tongue portions 214 into the buckle assembly 110, the second distal edge 217b of the second tongue portion 214b contacts the tip surfaces 560 of the ejector legs 542. Continued insertion of the tongue portions 214 causes the second tongue portion 214b to drive the ejector 342 back into the ejector base 344 and compress the springs 341 (FIGS. 3 and 5A). When the tongue portions 214 reach the position shown in FIG. 7C, they are fully inserted into the buckle assembly 110.

FIG. 7D is the same as FIG. 7C, except that part of the second tongue portion 214b has been omitted for purposes of clarity. As FIG. 7D shows, when the interlocking tongue portions 214 are fully inserted into the buckle assembly 110, the latch pawl 336 is driven upwardly through the aperture 224 in the first tongue portion 214a by the latch spring 346 (FIG. 3). In the upper position, the abutment surface 335 of the latch pawl 336 engages the locking edge 225 of the tongue aperture 224 and prevents the mated connectors 112 from being pushed out of the buckle assembly 110 by the spring-loaded ejector 342. Moreover, when the latch pawl 336 is engaged with the tongue portions 214 as described above, the connectors 112 cannot be withdrawn from the buckle assembly 110, thereby securing the restraint system 100 around the vehicle occupant 10 as illustrated in FIG. 1.

Referring next to FIGS. 7D and 7E together, when the user wishes to release the connectors 112 from the buckle assembly 110, he or she can depress the release button 222. Depressing the release button 222 drives the button legs 326 downwardly against the side members 337 of the latch 334. The resulting downward movement of the latch 334 in response to depression of the button 222 causes the latch pawl 336 to move downwardly and out of the tongue aperture 224. With the latch pawl 336 out of the way, the distal tip surfaces 560 of the ejector legs 542 can push the interlocking tongue portions 214 out of the buckle assembly 110 through the opening 220, thereby releasing the web connectors 112.

There are a number of advantages associated with embodiments of the buckle assembly 110 and the web connectors 112 described in detail above with reference to FIGS. 1-7E. For example, as shown in FIG. 7D, one advantage of these embodiments is that if the first tongue portion 214a were inserted into the buckle assembly 110 without the support of the second tongue portion 214b, it would be very difficult to inadvertently manipulate the first tongue portion 214a into a position where the latch pawl aperture 224 would engage the latch pawl 336. Even if the first tongue portion 214a were somehow manipulated into engagement with the latch pawl 336, the compressed ejector springs 341 (FIG. 3) would tend to drive the beveled surfaces 561 of the ejector legs 542 (FIG. 5B) against the distal edge 217a of the first tongue portion 214a. The upward force exerted by the beveled surfaces 561 against the distal edge 217a would tend to drive the first tongue portion 214a upwardly and off of the latch pawl 336. The distal end portions 546 of the ejector legs 542 would then push the first tongue portion out of the buckle assembly 110 without any partial engagement.

By way of another example, referring to FIG. 7B, if the second tongue portion 214b were inserted into the buckle assembly 110 without the first tongue portion 214a, the distal edge 217b of the second tongue portion 214b would contact the tip surfaces 560 of the ejector legs 542 (FIG. 5B) and compress the ejector springs 341. However, since the second tongue portion 214b does not have an aperture or opening that can receive and engage the latch pawl 336, the compressed ejector springs 341 would cause the ejector 342 to push the second tongue portion 214b out of the buckle assembly 110 without any partial engagement. Similarly, if the individual tongue portions 214 were correctly coupled together prior to insertion but were not fully inserted (locked) into the buckle assembly 110, the ejector 342 would eject both tongue portions 214 from the buckle assembly 110 as a unit without any partial engagement.

Section 7.2.1.1 of ECE Regulation No. 44 also states that “. . . it must not be possible to exchange the buckle parts inadvertently when the buckle is being locked; . . . ” As shown in FIG. 2B, the shape of the buckle opening 220 is not symmetrical about a horizontal axis and has shoulders 227 at each end. This shape corresponds to the shape of the coupled tongue portions 214 when they are inserted correctly through the opening 220. If the coupled tongue portions 214 are arranged incorrectly prior to insertion (e.g., upside down, inverted, etc.), the shape of the coupled tongues 214 will not fit through the opening 220. This prevents the tongue portions 214 from being inadvertently exchanged and then engaged with the buckle assembly 110. Although the first tongue portion 214a could be inserted upside down without the second tongue portion 214b, if it were it would not partially engage for the reasons discussed above. If the second tongue portion 214b were inverted, it would not fit through the opening 220. The features of the tongue portions 214 described above also help to ensure that the buckle assembly 110 only locks when all parts are engaged.

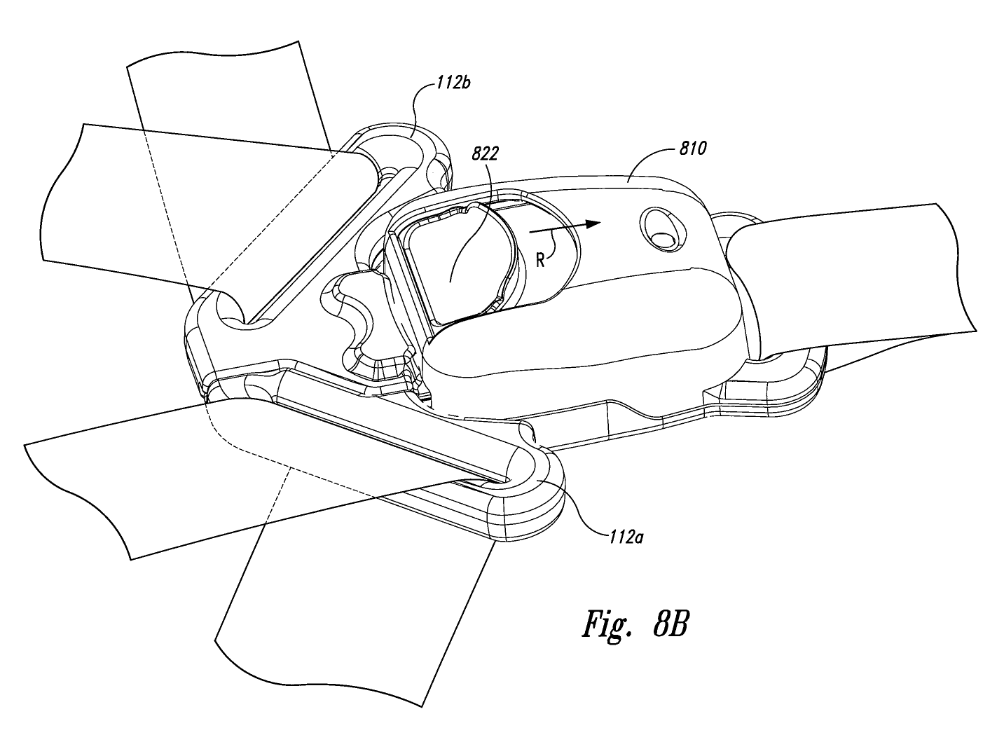

FIGS. 8A and 8B are isometric views illustrating various stages in a method of releasably coupling the first web connector 112a and the second web connector 112b to a buckle assembly 810 configured and in accordance with another embodiment of the disclosure. Referring first to FIG. 8A, the web connectors 112 are the same as, or are at least generally similar in structure and function to, the corresponding the web connectors 112 described in detail above. Accordingly, each of the web connectors 112 can slidably receive a corresponding shoulder web 102.

Many features of the buckle assembly 810 are at least generally similar in structure and function to the corresponding features of the buckle assembly 110 described in detail above with reference to FIGS. 1-7E. For example, to engage the web connectors 112 with the buckle assembly 810, the second tongue portion 214b is interlockingly engaged with the first tongue portion 214a, and the interlocked tongue portions 214 are then fully inserted through an opening 820 in the buckle assembly 810 as shown in FIG. 8B. In this particular embodiment, however, the buckle assembly 810 differs from the buckle assembly 110 in that a release actuator, e.g., a release button 822, is slid in direction R to release the web connectors 112 from the buckle assembly 810.

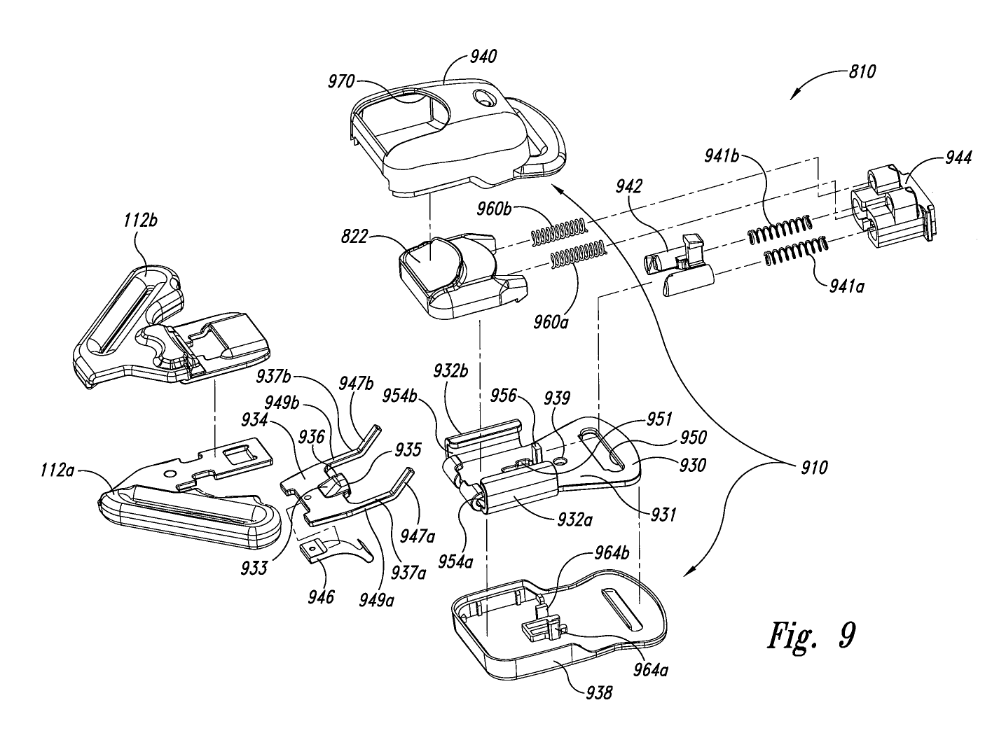

FIG. 9 is an exploded isometric view illustrating various components and features of the buckle assembly 810 in more detail. In one aspect of this embodiment, the buckle assembly 810 includes a frame 930 positioned in a housing 910. The housing 910 can include a bottom cover 938 and a corresponding top cover 940. The top cover 940 can include a button aperture 970 that slidably receives the release button 822. The bottom cover 938 can include two frame locating features 964 (identified individually as a first locating feature 964a and a second locating feature 964b) projecting upwardly therefrom. In one embodiment, the bottom cover 938 and the top cover 940 can be manufactured from a suitable plastic material. In other embodiments, however, the bottom cover 938 and/or the top cover 340 can be formed from other suitable materials known in the art including, for example, suitable metallic materials.

The frame 930 can be the same as, or at least generally similar in structure and function to, the corresponding frame 330 of the buckle assembly 110 described in detail above with reference to, e.g., FIG. 3. For example, the frame 930 can include opposing sidewalls 932 (identified individually as a first sidewall 932a and a second sidewall 932b) extending upwardly from a base 931. Each of the sidewalls 932 defines a corresponding inner-facing guide channel 954 (identified individually as a first guide channel 954a and a second guide channel 954b). A stop member 956 projects upwardly from the base 931 between an ejector locating aperture 939 and a cover locating aperture 951. Like the frame 330 described in detail above, the frame 930 also includes an attachment aperture 950 (e.g., a web attachment aperture) positioned toward an end portion of the base 931 for securely attaching the buckle assembly 810 to a crotch web, such as the crotch web 105 of FIG. 1. In the illustrated embodiment, the frame 930 can be manufactured from suitable metallic materials including, for example, a steel plate that is stamped and formed to shape. In other embodiments, other metals and other suitable materials known in the art can be used to manufacture the plate 930.

In another aspect of this embodiment, the buckle assembly 810 further includes a latch 934 having a pawl 936 projecting upwardly from a central portion of the latch 934 between opposing side members 937 (identified individually as a first side member 937a and a second side member 937b). The pawl 936 can be at least generally similar in structure and function to the pawl 336 described above with reference to FIG. 3. For example, the pawl 936 can include an angled ramp portion 933 and an abutment surface 935. The side members 937 extend away from the pawl 936 in parallel to each other. However, in the illustrated embodiment each side member 937 includes a distal end portion 947 (identified individually as a first distal end portion 947a and a second distal end portion 947b) that extends upwardly at an angle relative to a proximal end portion 949 (identified individually as a first proximal end portion 949a and a second proximal end portion 949b) of the corresponding side member 937. In one embodiment, for example, the distal end portions 947 can extend upwardly at an angle of from about 10 degrees to about 70 degrees, e.g., from about 20 degrees to about 50 degrees, or about 30 degrees relative to the proximal end portions 949. The latch 934 can be manufactured from various types of metallic and nonmetallic materials known in the art as having suitable strength and stiffness characteristics. Such materials can include, for example, steel forgings, castings, stampings, etc. As described in greater detail below, a portion of the release button 822 can contact the up-turned end portions 947 of the side members 937 to effectuate release of the buckle assembly 810 when the release button 822 is slid aft in the direction R (FIG. 8B).

The latch 934 can be operably coupled to a resilient biasing member or spring 946. In the illustrated embodiment, the spring 946 can be a curved member formed from spring steel that is at least generally similar in structure and function to the spring 346 described above with reference to, e.g., FIG. 3. In other embodiments, however, other types of resilient biasing members (e.g., coil springs, torsion springs, etc.) can be utilized to bias or urge the latch 934 in an upward direction during operation of the buckle assembly 810. To install the spring 946 on the latch 934, a U-shaped pocket on a first end portion of the spring 946 is pressed onto a leading edge portion of the latch 934 in the manner described above for the latch 334 of the buckle assembly 110 (see FIGS. 4A and 4B). The buckle assembly 810 can further include a tongue ejector 942 which compresses a pair of springs 941 (identified individually as a first spring 941a and a second spring 941b) against an ejector base 944.

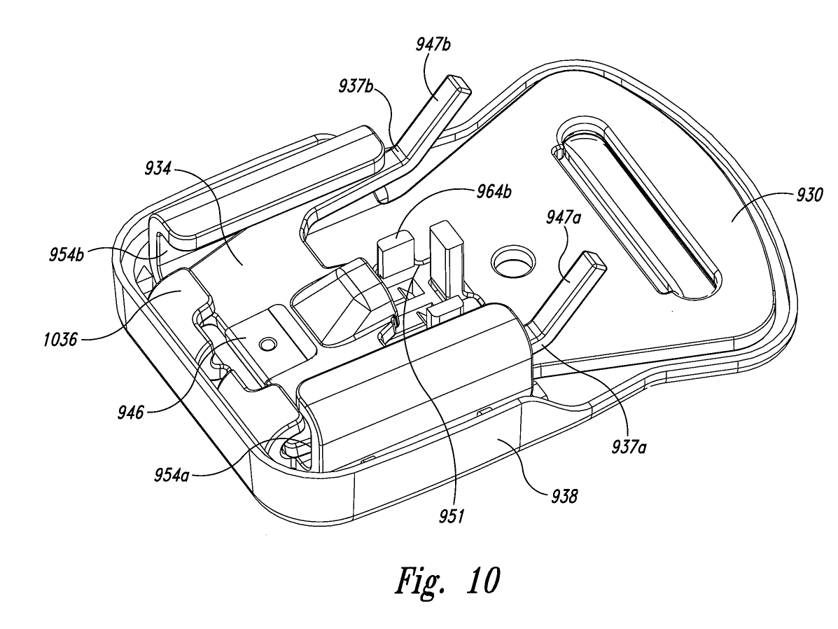

FIG. 10 is an isometric view illustrating installation of the latch 934 on the plate 930. The latch side members 937 can be slid into the corresponding guide channels 954 of the frame 930 until the leading edge portion of the latch 934 is received under a return flange 1036 of the frame 930. Once the latch 934 has been installed on the frame 930, the combination can be installed on the lower cover 938 so that the frame locating features 964 protrude upwardly through the cover locating aperture 951, as shown in FIG. 10.

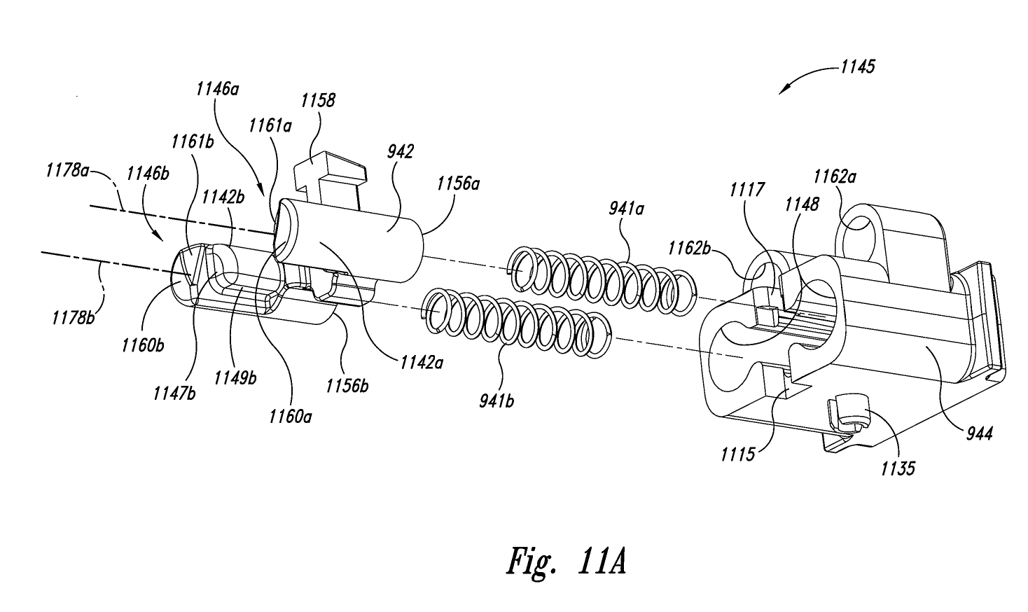

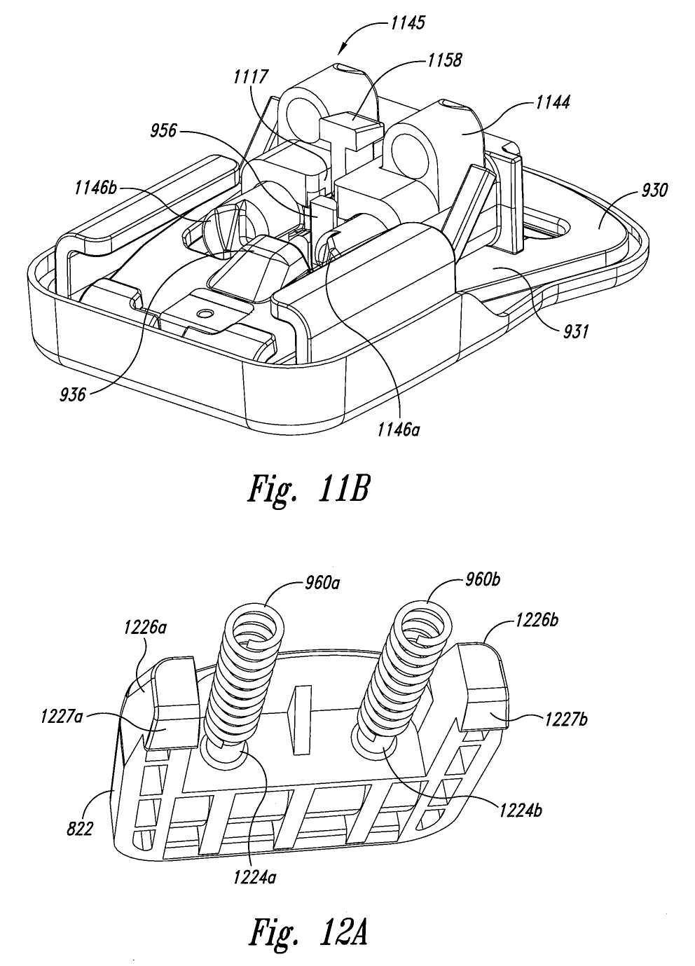

FIGS. 11A and 11B are isometric views illustrating the assembly of an ejector subassembly 1145, and subsequent installation of the ejector subassembly 1145 on the latch frame 930. Referring first to FIG. 11A, the ejector 942 includes a first leg 1142a and an adjacent second leg 1142b. In the illustrated embodiment, the ejector legs 1142 are essentially mirror images of each other. Each of the legs 1142 includes a distal end portion 1146 (identified individually as a first distal end portion 1146a and a second distal end portion 1146b), and a corresponding proximal end portion 1156 (identified individually as a first proximal end portion 1156a and a second proximal end portion 1156b). As with the ejector 342 described in detail above, each proximal end portion 1156 includes a corresponding spring cavity that receives a corresponding one of the coil springs 941.

In the illustrated embodiment, each distal end portion 1146 of the ejector legs 1142 includes a tip surface 1160, an adjacent chamfered or beveled surface 1161 oriented at an angle to the tip surface 1160, a recessed or offset surface 1147 that is set back from the tip surface 1160, and an undercut region 1149. In this embodiment, each of the tip surfaces 1160 can be perpendicular to, or at least generally perpendicular to, a longitudinal axis 1178 of the corresponding ejector leg 1142. As described above with respect to the ejector 342 of the buckle assembly 110, the tip surfaces 1160 of the ejector legs 1142 are configured to contact at least one of the tongue portions 214 (e.g., the second tongue portion 214b) of the web connectors 112 and be pushed back into the ejector base 944 when the interlocking tongue portions 214 are properly inserted into the buckle assembly 810. In addition, the offset surfaces 1147 and the undercut regions 1149 are configured to provide clearance between the ejector legs 1142 and the latch pawl 936 and the frame locating features 964 (FIG. 9), respectively, when the ejector 942 is pushed out of the ejector base 944 by the springs 941 during operation of the release mechanism.

In another aspect of this embodiment, each of the beveled surfaces 1161 can be positioned at an included angle of from about 115 degrees to about 165 degrees relative to the corresponding tip surface 1160. For example, each beveled surface 1161 can be positioned at an included angle of from about 125 degrees to about 145 degrees, or about 135 degrees relative to the corresponding tip surface 1160. As shown in FIG. 11A, each of the beveled surfaces 1161 of the illustrated embodiment can also be canted slightly upward at an angle relative to a plane passing through the longitudinal axes 1178 of both ejector legs 1142. For example, in one embodiment each of the beveled surfaces 1161 can be positioned at an included angle of from about 80 degrees to about 40 degrees relative to such a plane. In another embodiment, each of the beveled surfaces 1161 can be positioned at an included angle of from about 75 degrees to about 50 degrees, or about 65 degrees relative to the plane passing through the longitudinal axes 1178 of the ejector legs 1142.

In the illustrated embodiment, the beveled surfaces 1161 and/or the tip surfaces 1160 can be planar, or at least approximately planar. In other embodiments, however, the beveled surfaces 1161 and/or the tip surfaces 1160 can be curved or slightly curved. For example, in one embodiment the beveled surfaces 1161 and/or the tip surfaces 1160 can be slightly spherically or cylindrically concave. In another embodiment, the beveled surfaces 1161 and/or the tip surfaces 1160 can be slightly spherically or cylindrically convex. In yet other embodiments, it is contemplated that the beveled surfaces 1161 and/or the tip surfaces 1160 can have other shapes, e.g., other non-planar shapes, without departing from the spirit or scope of the present disclosure.

As described in greater detail below, the beveled surfaces 1161 on the distal end portions 1146 of the ejector legs 1142 are configured to prevent the first tongue portion 214a from inadvertently engaging the latch pawl 936 when the first tongue portion 214a is inserted into the latch assembly 810 in the absence of the second tongue portion 214b. In other embodiments, however, the distal end portions 1146 of the ejector legs 1142 can have configurations that differ from those described above without departing from the present disclosure. In the illustrated embodiment, the ejector 942 and/or the ejector base 944 can be made from a suitable plastic material, such as injection molded plastic. In other embodiments, however, one or both of these components can be made from other suitable materials, such as cast metal, etc.

The ejector base 944 includes two spring pockets 1162 (identified individually as a first spring pocket 1162a and a second spring pocket 1162b), an ejector aperture 1148, and an alignment feature 1135 extending downwardly therefrom. The proximal end portions 1156 of the ejector 942 are slidably inserted into the ejector base 944 through the ejector aperture 1148 to compress the coil springs 941 therewithin. As shown in FIG. 11B, the alignment feature 1135 can then be inserted into the ejector locating aperture 939 in the frame base 931 to correctly position the ejector subassembly 1145 on the frame 930 between the leg members 937 of the latch 934. As this view illustrates, when the ejector subassembly 1145 is in this position, the distal end portions 1146 of the ejector legs 1142 are positioned on opposite sides of the latch pawl 936. Moreover, the stop member 956 extends upwardly from the frame base 931 and is received in a corresponding recess 1115 (FIG. 11A) in the ejector base 944. The stop member 956 acts to restrict forward motion of the ejector 942 by blocking an ejector guide member 1158 that moves back and forth in an ejector channel 1117 in the ejector base 944.

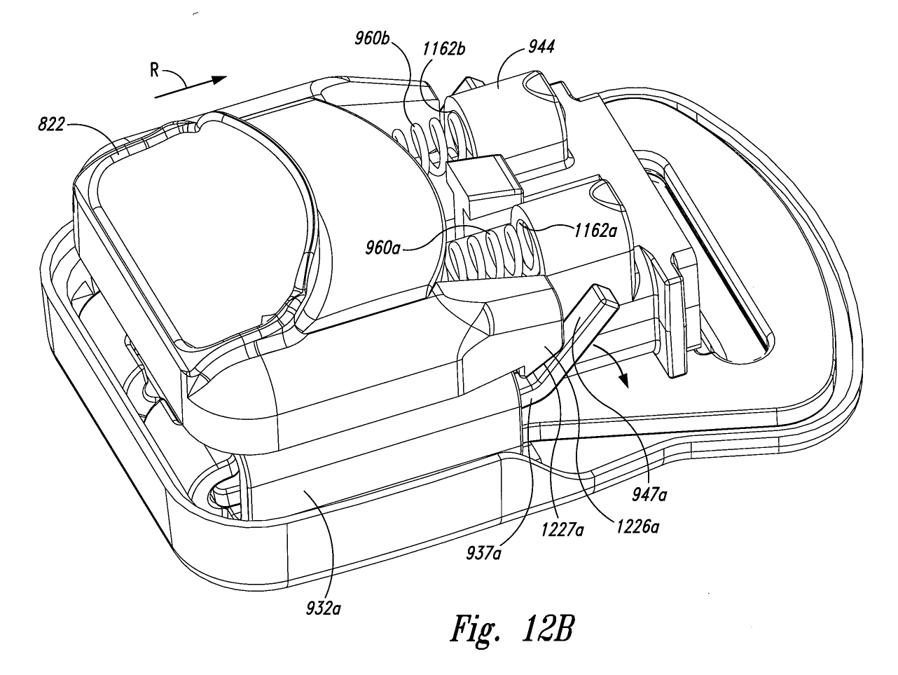

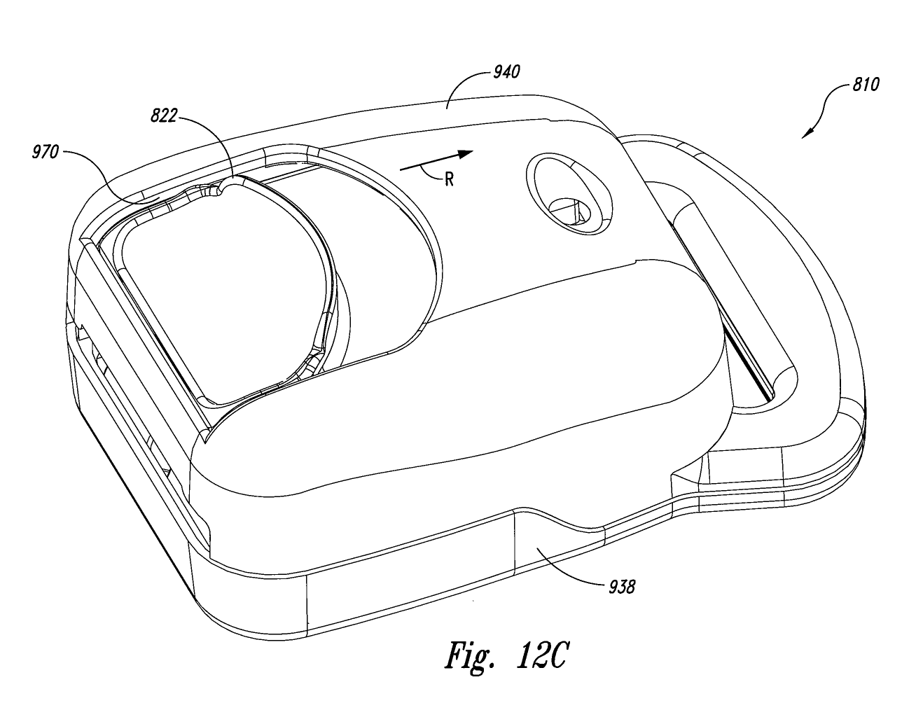

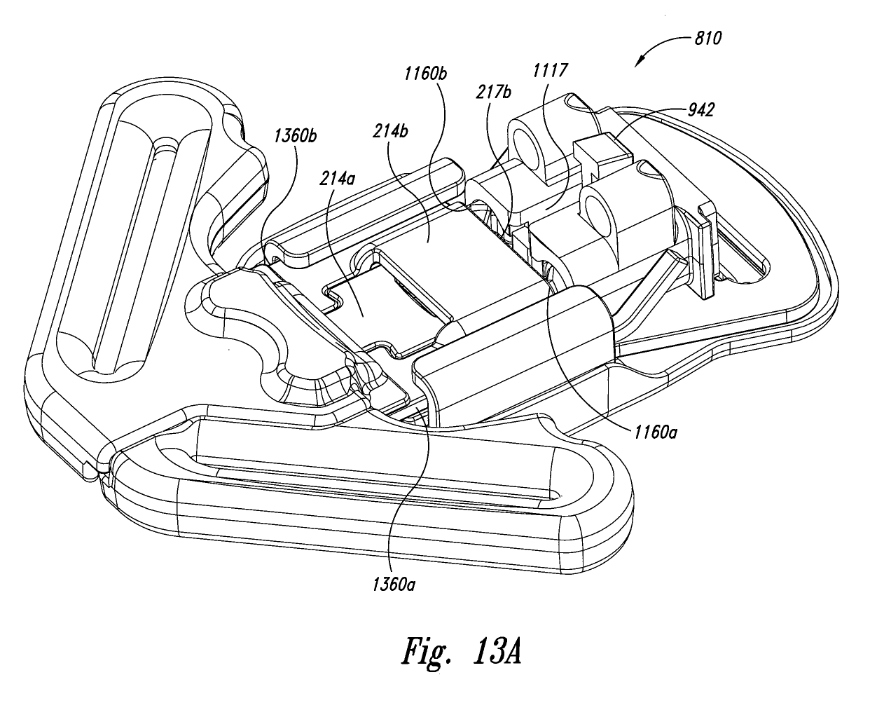

FIGS. 12A-12C are a series of isometric views illustrating various steps in the further assembly of the buckle assembly 810 in accordance with an embodiment of the disclosure. Referring first to FIGS. 9 and 12A together, the release button 822 is biased towards a forward, locked position by two biasing members, e.g., coil springs 960 (identified individually as a first coil spring 960a and a second coil spring 960b) which are compressed against an upper portion of the ejector base 944. As shown in FIG. 12A, each of the coil springs 960 is received on a corresponding locating feature, such as a spring post 1224 (identified individually as a first post 1224a and a second post 1224b) on an aft end portion of the release button 822. As this view further illustrates, the release button 822 also includes a first bearing or contact surface 1227a on a lower portion of a first arm 1226a, and a second contact surface 1127b on a lower portion of a second arm 1226b. As described in greater detail below, each of the contact surfaces 1227 is configured to bear against a corresponding distal end portion of one of the latch legs 937 when the button 822 is slid aft to the release position.

Referring next to FIG. 12B, the release button 822 is positioned on top of the frame sidewalls 932 so that the distal end portions of each of the coil springs 960 can be received in the corresponding spring pocket 1162 in the ejector base 944. As shown in FIG. 12C, after the release button 822 has been installed, the top cover 940 can be positioned on the bottom cover 938 and secured to the bottom cover using a plurality of fasteners (e.g., screws, not shown), adhesives, snap-together features, and/or other suitable attachment methods known in the art.

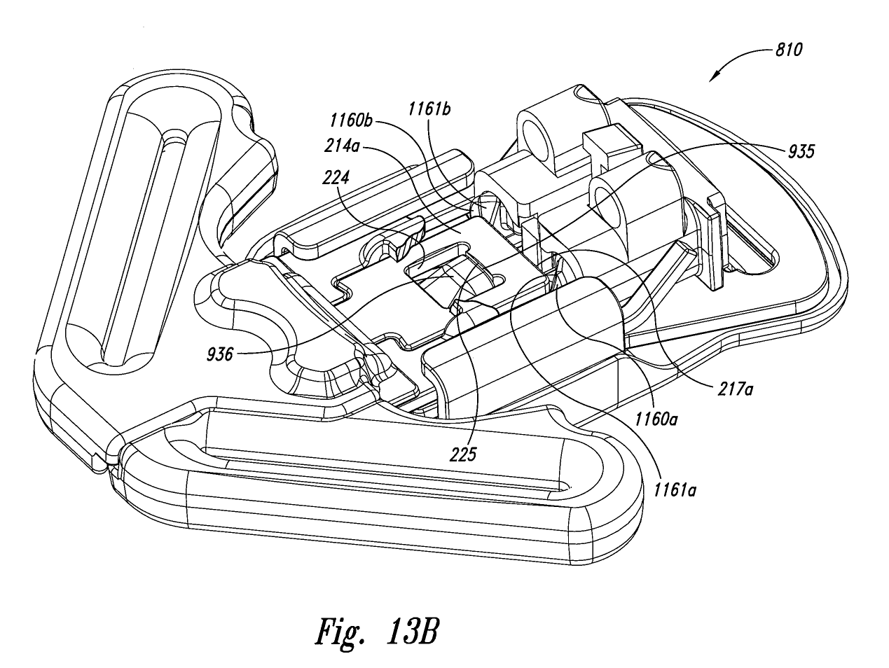

FIGS. 13A and 13B are partially assembled isometric views that are similar to FIGS. 7A and 7B described above with reference to the buckle assembly 110. Together with FIG. 12B, FIGS. 13A and 13B illustrate operation of the buckle assembly 810 in accordance with an embodiment of the disclosure. In FIGS. 13A and 13B, the upper cover 940 and the release button 822 have been omitted for clarity of illustration. Referring first to FIG. 13A, a user (not shown) correctly mates the first connector 112a to the second connector 112b as shown in, e.g., FIGS. 2A and 2B, and then inserts the interlocking tongue portions 214 into the buckle assembly 810 through the opening 820 (FIG. 8A). When the tongue portions 214 are properly inserted into the buckle assembly 810, outer edges 1360 (identified individually as a first outer edge 1360a and a second outer edge 1360b) of the second tongue portion 214b are slidably received in the guide channels 954 (FIG. 9) defined by the framed sidewalls 932. As the user continues pushing the interlocking tongue portions 214 into the buckle assembly 810, the second distal edge 217b of the second tongue portion 214b contacts the tip surfaces 1160 of the ejector legs 1142. Continued insertion of the tongue portions 214 causes the second tongue portion 214b to drive the ejector 942 back into the ejector base 944 and compress the springs 941 therewithin (FIGS. 9 and 11A). When the tongue portions 214 reach the position shown in FIG. 13A, they are fully inserted into the buckle assembly 810. As described below in reference to FIG. 13B, in this position the latch pawl 936 engages the tongue aperture 224 in the first tongue portion 214a.

FIG. 13B is the same as FIG. 13A, except that part of the second tongue portion 214b has been omitted for purposes of clarity. As FIG. 13B illustrates, when the interlocking tongue portions 214 are fully inserted into the buckle assembly 810, the latch pawl 936 is driven upwardly through the aperture 224 in the first tongue portion 214a by the latch spring 946 (FIG. 9). In the upper position, the abutment surface 935 of the latch pawl 936 engages the locking edge 225 of the tongue aperture 224 and prevents the mated connectors 112 from being pushed out of the buckle assembly 810 by the spring-loaded ejector 942. Moreover, when the latch pawl 936 is engaged with the tongue portions 214 as described above, the connectors 112 cannot be withdrawn from the buckle assembly 810 and thereby secure the restraint system 100 around the vehicle occupant 10 as illustrated in FIG. 1.

Referring to FIGS. 12B, 13A and 13B together, when the user wishes to release the connectors 112 from the buckle assembly 810, he or she can slide the release button 822 in direction R (FIG. 8B) and compress the coil springs 960. Sliding the release button 822 in this direction drives the contact surfaces 1227 on the button arms 1226 against the angled end portions 947 of the latch side members 937. The resulting downward movement of the side members 937 causes the latch pawl 936 to move downwardly and disengage from the tongue aperture 224. With the latch pawl 936 out of the way, the distal tip surfaces 1160 of the ejector legs 1142 can drive the interlocking tongue portions 214 out of the buckle assembly 810 through the opening 820, thereby releasing the web connectors 112.

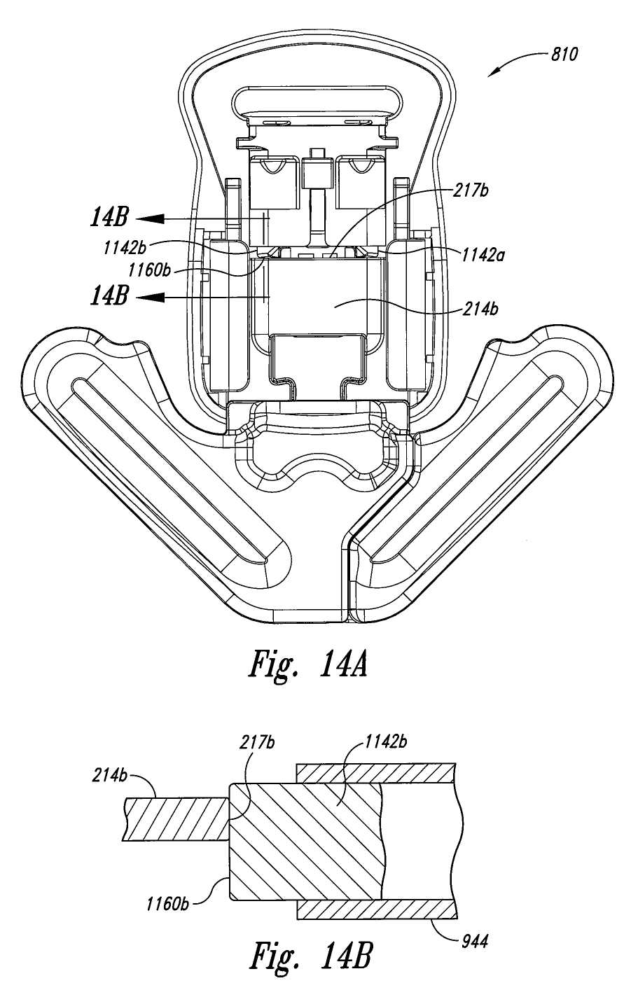

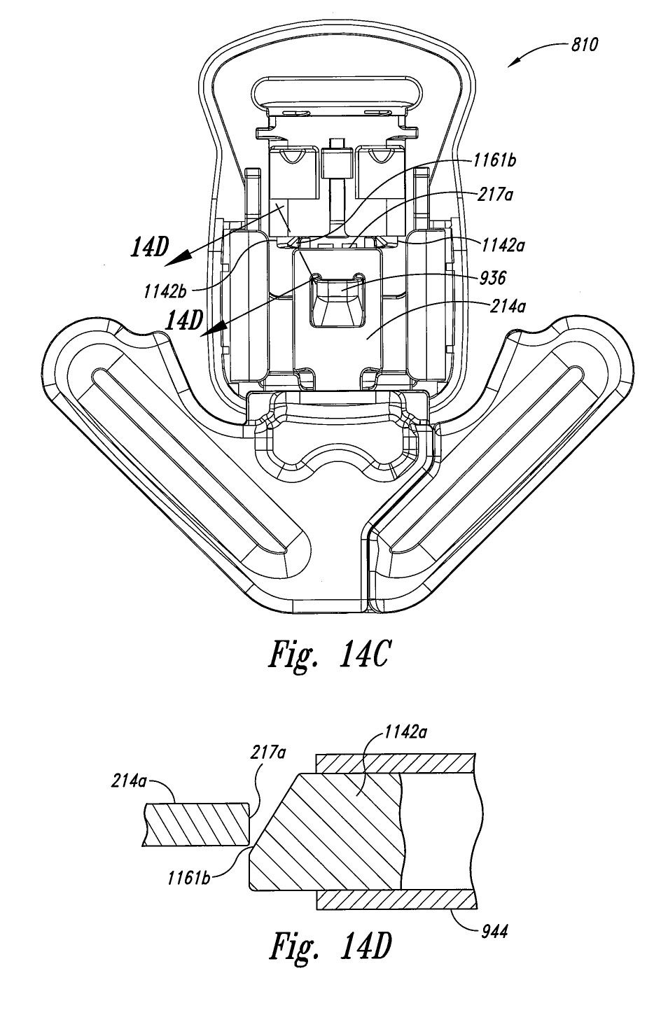

FIG. 14A is a top view of the buckle assembly 810, and FIG. 14B is a partial cross-sectional view of the buckle assembly 810 taken substantially along line 14B-14B in FIG. 14A. Referring first to FIG. 14A, the upper cover 940, the release button 822, and additional components of the buckle assembly 810 have been omitted from this view for purposes of clarity. In this view, the tongue portions 214 have been fully inserted into the buckle assembly 810 and properly engaged with the latch pawl 936 (FIG. 9). Referring next to FIG. 14B, in the illustrated embodiment, when the tongue portions 214 have been properly engaged with the buckle assembly 810, the tip surfaces 1160 of the ejector legs 1142 butt squarely against the second distal edge 217b of the second tongue portion 214b. For example, as this view illustrates, in this embodiment the tip surfaces 1160 can be parallel, or at least approximately parallel, to the second distal edge 217b. As explained above, the relationship of the tip surfaces 1160 to the second distal edge 217b enables the tip surfaces 1160 to push the tongue portions 214 straight, or at least generally straight, out of the buckle assembly 810 when the release button 822 is actuated.

FIG. 14C is a top view of the buckle assembly 810 that is similar to FIG. 14A. In FIG. 14C, however, the second tongue portion 214b is not shown to better illustrate the relationship between the beveled surfaces 1161 of the ejector legs 1142 and the first distal edge 217a of the first tongue portion 214a. Although the second tongue portion 214b is not shown, the first tongue portion 214a has been properly inserted in the buckle assembly 810 and engaged with the latch pawl 936 as if the second tongue portion 214b were present. Referring next to FIG. 14D, as this cross-sectional view illustrates, the beveled surfaces 1161 of the ejector legs 1142 are positioned at an angle relative to the first distal edge 217a when the first tongue portion 214a is engaged with the buckle assembly 810. For example, in one embodiment each of the beveled surfaces 1161 can be positioned at an angle of from about 10 degrees to about 50 degrees relative to the first distal edge 217a. In another embodiment, each of the beveled surfaces 1161 can be positioned at an angle of from about 15 degrees to about 40 degrees, or about 25 degrees relative to the first distal edge 217a. As explained above, the angled relationship of the beveled surfaces 1161 to the first tongue portion 214a enables the beveled surfaces 1161 to move the first tongue portion 214a upwardly and off of the latch pawl 936 if the first tongue portion 214a is inadvertently engaged with the latch pawl 936 in the absence of the second tongue portion 214b.

Although FIGS. 14A-14D and the associated discussion refer to the buckle assembly 810 for purposes of illustration, the description of the distal end portions 1146 of the ejector legs 1142 is equally applicable to the corresponding features of the buckle assembly 110 described above with reference to FIGS. 1-7E. For example, in various embodiments the distal end portions 546 of the ejector legs 542 (FIGS. 3 and 5B) can be at least generally similar in structure and function to the distal end portions 1146 of the corresponding ejector legs 1142 (FIGS. 9 and 11A). Accordingly, in these embodiments the tip surfaces 560 and the beveled surfaces 561 of the ejector legs 542 can have the same configuration as, or be at least generally similar to, the tip surfaces 1160 and the beveled surfaces 1161, respectively, of the ejector legs 1142 as described above with reference to FIGS. 14A-14D.

As described above with regard to the buckle assembly 110, one advantage of the buckle assembly 810 is that it is very difficult to inadvertently engage the latch pawl 936 if the first tongue portion 214a is inserted into the buckle assembly 810 without the second tongue portion 214b. More specifically, if this were to happen, the compressed coil springs 960 would drive the beveled surfaces 1161 on the distal end portions 1146 of the ejector legs 1142 against the distal edge 217a of the first tongue portion 214a. The beveled surfaces 1161 would then tend to drive the first tongue portion 214a upwardly and off of the latch pawl 336, because of the relative angle between the beveled surfaces 1161 and the distal edge 217a of the first tongue portion 214a as shown in FIG. 13B.

Similarly, if the second tongue portion 214b was inserted into the buckle assembly 810 without the first tongue portion 214a, the distal edge 217b of the second tongue portion 214b would contact the tip surfaces 1160 of the ejector legs 1142 and compress the ejector springs 941. However, since the second tongue portion 214b does not have an opening or aperture that can engage the latch pawl 936, the ejector 942 would push the second tongue portion 214b out of the buckle assembly 810 without any partial engagement of the latch pawl 936, as long as there was no external force holding the connector 112b in the buckle assembly 810. In addition, if the individual tongue portions 214 are correctly mated together prior to insertion but are not fully inserted into the buckle assembly 810, the ejector 942 will drive both tongue portions 214 out of the buckle assembly 810 as a unit without partial engagement because the latch pawl 936 cannot engage the tongue aperture 224 unless the mated tongue portions 214 are fully inserted into the buckle assembly 810.

From the foregoing, it will be appreciated that specific embodiments of the disclosure have been described herein for purposes of illustration, but that various modifications may be made without deviating from the spirit and scope of the various embodiments of the disclosure. Further, while various advantages associated with certain embodiments of the disclosure have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A personal restraint system for use in a vehicle, the personal restraint system comprising:
a first connector configured to be operably coupled to a first web, wherein the first connector includes a first tongue portion having a locking feature;
a second connector configured to be operably coupled to a second web, wherein the second connector includes a second tongue portion; and
a buckle assembly, the buckle assembly including:
a latch configured to engage the locking feature of the first tongue portion to thereby lock the first and second tongue portions to the buckle assembly when the first and second tongue portions are inserted into the buckle assembly together; and
an ejector configured to disengage the locking feature from the latch when the first tongue portion is inserted into the buckle assembly in the absence of the second tongue portion.

2. The personal restraint system of claim 1 wherein the ejector is further configured to drive the second tongue portion away from the latch when the second tongue portion is inserted into the buckle assembly in the absence of the first tongue portion.

3. The personal restraint system of claim 1 wherein the latch includes a pawl configured to engage the locking feature of the first tongue portion to lock the first and second tongue portions to the buckle assembly when the first and second tongue portions are inserted into the buckle assembly together, and wherein the ejector is configured to disengage the locking feature from the pawl when the locking feature is engaged with the pawl in the absence of the second tongue portion.

4. The personal restraint system of claim 1 wherein the first tongue portion includes an aperture, and wherein the aperture includes the locking feature.

5. The personal restraint system of claim 1 wherein the first tongue portion includes an aperture, and wherein the latch includes a pawl configured to engage an edge portion of the aperture to lock the first and second tongue portions to the buckle assembly when the first and second tongue portions are inserted into the buckle assembly together.

6. The personal restraint system of claim 1 wherein the ejector includes at least one surface configured to contact a distal edge of the first tongue portion and lift the first tongue portion free of the latch when the locking feature is engaged with the latch in the absence of the second tongue portion.

7. The personal restraint system of claim 1:
wherein the ejector includes a distal end portion having a first surface adjacent to a second surface;
wherein the first surface is configured to contact a first distal edge of the first tongue portion and disengage the locking feature from the latch when the first tongue portion is inserted into the buckle assembly in the absence of the second tongue portion; and
wherein the second surface is configured to contact a second distal edge of the second tongue portion and drive the second tongue portion away from the latch when the second tongue portion is inserted into the buckle assembly in the absence of the first tongue portion.

8. The personal restraint system of claim 1:
wherein the ejector includes at least one ejector leg having distal end portion;
wherein the distal end portion has a first surface adjacent to a second surface, wherein the first surface is at least approximately perpendicular to a longitudinal axis of the ejector leg, and wherein the second surface is positioned at an angle to the first surface;
wherein the first surface is configured to contact a first distal edge of the first tongue portion and disengage the locking feature from the latch; and
wherein the second surface is configured to contact a second distal edge of the second tongue portion and drive the second tongue portion away from the latch.

9. A child restraint system for use with a child seat in a vehicle, the restraint system comprising:
a first connector configured to be operably coupled to a first web, wherein the first connector includes a first tongue portion having an aperture therein;
a second connector configured to be operably coupled to a second web, wherein the second connector includes a second tongue portion configured to be releasably interlocked with the first tongue portion; and
a buckle assembly, the buckle assembly including:
a latch pawl configured to extend at least partially through the aperture and releasably engage the first tongue portion when the first and second tongue portions are releasably interlocked and inserted into the buckle assembly together; and
an ejector having a first surface portion and a second surface portion, wherein the first surface portion is configured to disengage the first tongue portion from the latch pawl when the first tongue portion is inserted into the buckle assembly in the absence of the second tongue portion, and wherein the second surface portion is configured to drive the second tongue portion away from the latch pawl when the second tongue portion is inserted into the buckle assembly in the absence of the first tongue portion.

10. The child restraint system of claim 9 wherein the first surface portion of the ejector is positioned at an angle relative to the second surface portion of the ejector.

11. The child restraint system of claim 9 wherein the first and second surface portions define an angle therebetween of from about 115 degrees to about 165 degrees.

12. The child restraint system of claim 9 wherein the first tongue portion includes a first distal edge and the second tongue portion includes a second distal edge, wherein the first surface portion of the ejector is disposed at an angle relative to the first distal edge, and wherein the second surface portion of the ejector is parallel relative to the second distal edge.

13. The child restraint system of claim 9 wherein the ejector includes at least one leg extending therefrom along a longitudinal axis, wherein the first surface portion is positioned at an angle relative to the longitudinal axis, and wherein the second surface portion is at least approximately perpendicular to the longitudinal axis.

14. The child restraint system of claim 9:
wherein the ejector further includes a first leg disposed toward a first side of the latch pawl and a second leg disposed toward a second side of the latch pawl opposite the first side;
wherein the first leg includes a first distal end portion and the second leg includes a second distal end portion;
wherein the first distal end portion of the first leg includes the first and second surface portions; and
wherein the second distal end portion of the second leg includes third and fourth surface portions, wherein the first and third surface portions are configured to disengage the first tongue portion from the latch pawl when the first tongue portion is inserted into the buckle assembly in the absence of the second tongue portion, and wherein the second and fourth surface portions are configured to drive the second tongue portion away from the latch pawl when the second tongue portion is inserted into the buckle assembly in the absence of the first tongue portion.

15. The child restraint system of claim 9:
wherein the ejector further includes a first leg extending therefrom along a first longitudinal axis first and a second leg extending therefrom along a second longitudinal axis;
wherein the first leg is disposed toward a first side of the latch pawl and the second leg is disposed toward a second side of the latch pawl opposite the first side;
wherein the first leg includes the first and second surface portions and the second leg includes third and fourth surface portions;
wherein the first surface portion is positioned at an angle relative to the first longitudinal axis and the second surface portion is at least approximately perpendicular to the first longitudinal axis; and
wherein the third surface portion is positioned at an angle relative to the second longitudinal axis and the fourth surface portion is at least approximately perpendicular to the second longitudinal axis.

16. The child restraint system of claim 9 wherein the buckle assembly further comprises:
a frame; and
a biasing member operably disposed between the frame and the ejector, wherein the biasing member urges the first surface portion of the ejector against a first distal edge of the first tongue portion when the first tongue portion is inserted into the buckle assembly, and wherein the biasing member further urges the second surface portion of the ejector against a second distal edge of the second tongue portion when the second tongue portion is inserted into the buckle assembly.

17. The child restraint system of claim 9 wherein the buckle assembly further comprises:
a housing;
a release actuator operably coupled to the housing;
a frame positioned at least partially within the housing;
an ejector base mounted to the frame; and
at least one biasing member operably disposed between the ejector base and the ejector;
wherein the ejector further includes a first ejector leg extending therefrom along a first longitudinal axis first and a second ejector leg extending therefrom along a second longitudinal axis;
wherein the first ejector leg is disposed toward a first side of the latch pawl and the second ejector leg is disposed toward a second side of the latch pawl opposite the first side;
wherein the first ejector leg includes the first and second surface portions and the second ejector leg includes third and fourth surface portions;
wherein the first surface portion is positioned at an angle relative to the first longitudinal axis and the second surface portion is positioned at least approximately perpendicular to the first longitudinal axis;
wherein the third surface portion is positioned at an angle relative to the second longitudinal axis and the fourth surface portion is positioned at least approximately perpendicular to the second longitudinal axis; and
wherein the biasing member urges the second surface portion of the first ejector leg and the fourth surface portion of the second ejector leg against the second tongue portion to eject the second tongue portion and the first tongue portion from the buckle assembly when the release actuator is manually actuated.

18. A buckle system for restraining a child in a child seat in a vehicle, the buckle system comprising:
a first connector configured to be operably coupled to a first web, wherein the first connector includes a first tongue portion having a locking feature;
a second connector configured to be operably coupled to a second web, wherein the second connector includes a second tongue portion; and
a buckle assembly configured to be operably coupled to a third web, the buckle assembly including:
means for engaging the locking feature of the first tongue portion to secure the first and second tongue portions to the buckle assembly when the first and second tongue portions are inserted into the buckle assembly together; and
means for automatically disengaging the locking feature to release the first tongue portion from the buckle assembly when the first tongue portion is inserted into the buckle assembly in the absence of the second tongue portion.

19. The buckle system of claim 18, further comprising means for automatically driving the second tongue portion out of the buckle assembly when the second tongue portion is inserted into the buckle assembly in the absence of the first tongue portion.

20. The buckle system of claim 18, further comprising means for releasing the first and second tongue portions from the buckle assembly when the first and second tongue portions are inserted into the buckle assembly together and the locking feature is engaged.
